(19) United States
(12) Patent Application Publication
(10) Pub. No.: US 2010/0221693 A1
(43) Pub. Date: Sep. 2, 2010

(54) Instant Messaging For A Virtual Learning Community

(76) Inventor: Rakesh Kumar Gupta, Singapore (SG)

Correspondence Address: LAWRENCE Y.D. HO & ASSOCIATES PTE LTD, 30 BIDEFORD ROAD, #02-02, THONGSIA BUILDING, SINGAPORE, 229922, SG

(21) Appl. No.: 12/293,823

(22) PCT Filed: Mar. 31, 2006
(86) PCT No.: PCT/SG06/00079

§ 371 Date: Sep. 22, 2008

(51) Int. Cl. G09B 3/00; G06F 15/16

(52) U.S. Cl. 434/362; 709/206; 709/227; 709/219; 434/322; 709/204

(57) ABSTRACT

The present invention provides an Instant Messaging (IM) System (100) for a Virtual Learning Community (VLC). Clients (150) or user of the VLC are differentiated in their roles, and appropriate rules are set for each role by a Role Extension engine (124c). A user (150) is now allowed to appear with separate roles across separate groups. The Role Extension engine (124c) returns a structured contact list (192a) to a user and an Activation engine 124g updates the user presence information in a VLC Messenger Database 112. A roster engine (14, 25,26) then updates the presence of all the clients who has logged-on to a VLC Server (120), which comprises a VLC Database Server (122), a VLC Web Server (124) and a VLC Messenger Server (126). With the Role Extension engine (124c) together with VLC Client Application Tools (151), a lecturer or teaching assistant (TA) is able to monitor a virtual classroom in session and records students' attendance, inputs and participation. A lecturer can review the TA assessments and publish the students' progress report for continuous assessments. Classroom interaction is now enhanced, for example, a lecturer can take control over a student's desktop, mark a point on the student's desktop and broadcast the captured desktop to his group of students.

### FIELD OF THE INVENTION

The present invention relates to an Instant Messaging (“IM”) system and method that support structured roles within a virtual learning community. With structured user roles, the instant messaging system allows users to interact actively in virtual classrooms in a campus-wide cyberspace.

### BACKGROUND

An Instant Messaging (“IM”) system is a client-server system. The IM server tracks the presence information of IM clients that an IM client has subscriptions to. The IM system thus links these IM clients together and allows the IM clients to exchange messages. FIG. 1 depicts typical IM Clients 11, 12, 13 connected to an IM Server 10. The IM Server 10 runs a roster engine 14. The roster engine 14 manages transactions and associated roster subscription details of the IM clients connected to the IM Server 10. The roster subscription details of the IM clients are stored in a Repository 15. For example, as shown in FIG. 1, the IM Client 11 connects up with the IM Server 10 and notifies the IM Server 10 that it is connected. The IM Server 10 returns a list of contacts to IM Client 11 together with their presence information from the Repository 15. The contact list contains the contact details of those clients who have subscribed to both the IM Server 10 and the IM Client 11. The IM Client 11 then sends out its presence information to the IM Server 10 stating that it is “available”. The IM Server 10 updates its Repository 15 and simultaneously sends the presence information of IM Client 11 to all clients that have subscribed to the IM Client 11. For example, as shown in a roster 17 in FIG. 1, IM Client 12 has IM Client 11 in its contact list (but not IM Client 13), the IM Server 10 would send the presence information of IM Client 11 to IM Client 12 only.

In a multi-servers IM architecture as shown in FIG. 2, there are several ways an IM client connected to one IM server can see another IM client who is connected to a separate IM server. One way for an IM server to see another server is shown in FIG. 2 for two IM servers 20, 21. As shown in FIG. 2, the IM Server 20 is required to subscribe to the other IM Server 21. This requires the IM Server 20 to broadcast the presence information of all its clients, for example IM Clients 22, 23 and the IM Server 21, that have subscribed to the IM Server 20. As shown in FIG. 2, each IM Server 20, 21 has its own respective roster engine 25, 26 but a common repository 27. The client-server subscriptions are shown in a roster 28. This multi-servers architecture allows an IM system to be scalable and to support many thousands and potentially millions of users.

Prior art Instant Messenger (IM) systems, such as MSN, Yahoo, AOL and so on, can therefore provide computer users who have subscribed to and are connected on-line to a service provider's server to “chat” or exchange messages/files instantaneously. Some of these messaging may not be routed through the service provider's server but directly with other IM clients by communicating through the use of Peer-to-Peer protocols after the IM server has/servers have linked the IM clients together. Prior art IM systems also provide fully asynchronous communication. Hence, an IM system can provide a suitable platform for implementing a virtual learning system in a community, such as an educational institution.

Implementing an IM system in an educational institution or institutions of learning/training poses many advantages and challenges. For example, some students may have personal or family commitments, such as mature students having to work part-time and requiring flexible lesson time. Other students may require different levels of tutoring and interactions with fellow students and/or lecturers/tutors; a limitation of prior art IM systems is that users have no structural hierarchy and roles. In a classroom, be it in a physical or virtual world, a lecturer should be differentiated from a student, and a lecturer has control over students' discussions. Attendance and participation in a virtual classroom need to be monitored. Students also need to know their assessments or grades for each elective/course of study taken, especially on a continuous basis. Furthermore, only an administrator can create courses and sign-up students for their respective courses/electives.

When using a prior art IM system, a student, for example, would need to manually add the names of their classmates into their contact lists. It would be inefficient for each of all, say 50, students to add their classmates into their respective contact list online. Some corporate IM systems are able to load their contact lists automatically. However, it only allows one level of grouping, therefore lacks a hierarchy structure. Another limitation of a prior art IM system is that when two or more groups are created, a user cannot appear in more than one group. Updating of a user's contact list would be a chore especially in a learning community when groups of students are re-grouped each time a new semester begins or a course/elective is completed.

US patent publication no. 2004/0248597 assigned to Motorola Inc, et al. describes an emergency response system with Instant Messaging and role-based contact lists. A user contacts a role based contact list entry corresponding to a job function or role of a responder, for example, police, fire, medical, electrician, plumber, etc. An initiation server receives responder status updates and transmits the updates as role-based contact to the messaging client. However, none of the responder contact is duplicated in the contact list.

US patent publication no. 2005/0071433 assigned to Sun Microsystems describes a method and system for processing instant messenger (IM) operations dependent upon presence state information. In one example, the presence state, such as “idle” or “busy”, corresponds to the activity of a user computer based on a threshold level or threshold time.

In learning institutions, there is a need to redefine some of the features available from prior art instant messengers. As IM system is relatively new in the educational institutions and institutions of learning, an approach is to enhance the existing IM systems to allow lecturers, teaching assistants (TAs) and students to harness the power of IM so that lecturers and TAs, for example, can use the IM platform in their daily activities of running lectures, monitoring and tracking students' progress; and students can start peer sessions amongst themselves. This would enhance lecturers-students or students-students collaborations within a virtual classroom and beyond. Such collaborations in cyberspace call for users to share computer screens and work on screen-captured images, just as teachers and students would use a white/black board in a conventional classroom. Building these functionalities on an Instant Messaging platform would add new dimensions to both institutional education management and classroom management in cyberspace.

It can thus be seen that there exists a need for implementing an IM system in a campus-wide institution that can minimize if not overcome the limitations of prior art IM systems.

### SUMMARY

In one embodiment, the present invention provides an Instant Messaging (IM) system for a Virtual Learning Community (VLC) with VLC Clients including lecturers, teaching assistants, researchers, students and administrators, said system comprising: a VLC server comprising at least three logical servers, namely a VLC Database Server, a VLC Application Server and a VLC Messenger Server, with the VLC Messenger Server running an extensible Messaging and Presence Protocol (XMPP); and engines running on the VLC Application Server with pluggable extensions for interfacing with said XMPP.

In another embodiment of the IM system, one of the VLC Application Server extension engines comprises a Role Extension engine, which extends the presence information of a VLC Client with a role differentiation so that the VLC Client is allowed to appear in two or more contact groups with different roles.

In another embodiment of the IM system, one of the VLC Application Server extensions engine further comprising a File Transfer engine. The File Transfer engine allows a VLC Client to pause and resume a file transfer when the VLC Client is on-line. In addition, the File Transfer engine sends a file to a recipient VLC Client one at a time as each one logs-in to the system.

In yet another embodiment of the IM system, each VLC Client executes an application in one's input device, said application provides a Common Tools, a Group Tools and a Class Session Tools. In an embodiment of the Common Tools, it comprises a User Information tool, a Chat tool, a Whiteboard tool, a Screen Sharing tool, a Desktop Sharing tool and a File Transfer tool. The Screen sharing tool allows a VLC Client to share and work on screen captures in cyberspace just like a black/white board in a physical classroom. The Session Tools provide a VLC Client lecturer/TA with a Teaching Assistant Tools window and a Classroom Presenter window.

In another embodiment of the present invention, a method for implementing Instant Messaging (IM) in a Virtual Learning Community (VLC) is provided. The VLC has VLC Clients including lecturers, teaching assistants, researchers, students and administrators, said method comprising the steps of: linking VLC Clients to a VLC Messenger Server; running an eXtensible Messaging and Presence Protocol (XMPP) on the VLC Messenger Server, said XMPP having extensible and plugable interfaces; and running functional engines on a VLC Application Server to cooperate with the XMPP extensible and pluggable interfaces.

In another embodiment of the IM method, one of the functional engines comprises a role Extension engine. After a successful sign-in request is authenticated by a directory server, a roster and presence data from the VLC Messenger Server is intercepted by the Role Extension engine, which then returns a structured contact list with role, grouping and presence information to the VLC Client so that the VLC Client is allowed to appear in two or more contact groups with different roles.

In another embodiment of the IM method, the VLC application is further configured to run functional extension engines comprising: a Data Manager, a Conference engine, a File Transfer engine, a Session engine, a Session Workflow engine and an Activation engine. In an embodiment of the File Transfer method, the file transfer engine allows a VLC Client to pause and resume a file transfer when the VLC Client is on-line. In addition, the File Transfer engine sends a file to a recipient VLC Client one at a time as each VLC Client logs-in to the system.

In another embodiment of the IM method, each VLC Client executes an application in one's input device, said application providing a Common Tools, a Group Tools and a Class Session Tools. In an embodiment of the Common Tools, it comprises a User Information tool, a Chat tool, a Whiteboard tool, a Screen Sharing tool, a Desktop Sharing tool and a File Transfer tool. The Screen Sharing tool allows a VLC Client to share and work on screen captures in cyberspace just like a black/white board in a physical classroom. The Session Tools provide a VLC Client lecturer/TA with a Teaching Assistant Tools window and a Classroom Presenter window.

In yet another embodiment of the present invention, a computer program stored on a computer readable medium for running an Instant Messaging (IM) program for a Virtual Learning Community is provided. The computer program comprising: an eXtensible Messaging and Presence Protocol (XMPP) having extensible and pluggable interfaces, said XMPP runs on a VLC Messenger Server; and VLC Application engines cooperating with the extensible and pluggable interfaces of the XMPP, said VLC Application engines run on a VLC Application Server; wherein said VLC Messenger Server and VLC Application Server are connected to a VLC Database Server.

In an embodiment of the IM computer program, one of the VLC Application engine comprises a Role Extension engine, which extends the presence information of a VLC Client with a role differentiation so that the VLC Client is allowed to appear in two or more contact groups with different roles.

In another embodiment of the IM computer program, VLC Application engine further comprising: a Data Manager, a Conference engine, a File Transfer engine, a Session engine, a Session Workflow engine and an Activation engine. In an embodiment of the File Transfer program, the file transfer engine allows a VLC Client to pause and resume a file transfer when the VLC Client is on-line. In addition, the File Transfer engine sends a file to a recipient VLC Client one at a time as each VLC Client logs-in to the system.

In another embodiment of the IM computer program, each VLC Client executes an application in one's input device, said client application providing a Common Tools program, a Group Tools program and a Class Session Tools program. In an embodiment of the Common Tools program, it comprises a User Information tool, a Chat tool, a Whiteboard tool, a Screen Sharing tool, a Desktop Sharing tool and a File Transfer tool. The Screen Sharing tool program allows a VLC Client to share and work on screen captures in cyberspace just like a black/white board in a physical classroom. The Session Tools provide a VLC Client lecturer/TA with a Teaching Assistant Tools window and a Classroom Presenter window.

### BRIEF DESCRIPTION OF THE DRAWINGS

This invention will be described by way of non-limiting embodiments of the present invention, with reference to the accompanying drawings, in which:

FIG. 1 illustrates a prior art client-server Instant Messaging architecture;

FIG. 2 illustrates a prior art multi-servers Instant Messaging architecture;

FIG. 3 illustrates a Virtual Learning Community Instant Messaging architecture for an institution according to an embodiment of the present invention;

FIG. 4 illustrates Virtual Learning Community Instant Messaging systems of two institutions connected together through the internet according to another embodiment of the present invention;

FIG. 5A shows Tables 1A-1F containing data structures of an Institution Database according to an embodiment of the present invention; and

FIG. 5B shows a mapping of the Institution Database data structures shown in FIG. 5A.

FIG. 6 illustrates an IM system employing a load balancer according to another embodiment of the present invention;

FIG. 7 illustrates various engines of the VLC Application Server according to another embodiment of the present invention;

FIG. 8A shows Tables 2A-2Q containing data structures of a VLC Campus Database according to an embodiment of the present invention; and

FIG. 8B shows a mapping of the VLC Campus Database data structures shown in FIG. 8A;

FIG. 9A shows Tables 3A-3K containing data structures of a VLC Messenger Database according to an embodiment of the present invention; and

FIG. 9B shows a mapping of the VLC Messenger Database data structures shown in FIG. 9A;

FIG. 10 illustrates a VLC Client contact list of a lecturer returned by a Role Extension engine according to another embodiment of the present invention;

FIG. 11 illustrates three separate roles of VLC Clients in the contact list shown in FIG. 10;

FIG. 12A illustrates a VLC activation process according to another embodiment of the present invention; and

FIG. 12B illustrates an entire logon process to the VLC Messenger Server according to another embodiment of the present invention;

FIG. 13 illustrates components of the VLC Client Application framework according to another embodiment of the present invention;

FIG. 14 illustrates a User Information window according to another embodiment of the present invention;

FIG. 15 illustrates a Chat Tool window according to another embodiment of the present invention;

FIG. 16 illustrates a Whiteboard window according to another embodiment of the present invention;

FIG. 17 illustrates a Screen Sharing Tool window according to another embodiment of the present invention;

FIG. 18 illustrates a Desktop Sharing tool window according to another embodiment of the present invention;

FIG. 19 illustrates a File Transfer monitor according to another embodiment of the present invention;

FIG. 20 illustrates a Student Peer session window according to another embodiment of the present invention;

FIG. 21 illustrates a Group Chat window according to another embodiment of the present invention;

FIG. 22 illustrates a Poll engine window according to another embodiment of the present invention;

FIG. 23 illustrates a Teaching Assistant reporting window according to another embodiment of the present invention;

FIG. 24 illustrates a lecturer's Session window according to another embodiment of the present invention;

FIG. 25 illustrates a Students tab in a Class Session window according to another embodiment of the present invention;

FIG. 26 illustrates a Note tag window for recording a student's performance according to another embodiment of the present invention;

FIG. 27 illustrates a Student Progress Report window according to another embodiment of the present invention;

FIG. 28 illustrates a Question Manager window according to another embodiment of the present invention;

FIG. 29 illustrates an Assessment Manager window according to another embodiment of the present invention;

FIG. 30 illustrates an Assessment Monitor window according to another embodiment of the present invention;

FIG. 31 illustrates an Assessment Statistics window according to another embodiment of the present invention;

FIG. 32 illustrates a window showing five types of Assessment questions according to another embodiment of the present invention; and

FIG. 33 illustrates a Classroom Presenter window according to yet another embodiment of the present invention.

### DETAILED DESCRIPTION

Systems and methods for implementing Instant Messaging (IM) in a virtual educational or training environment are described with preferred embodiments. In the following description, details are provided to describe specific and alternative embodiments of an IM system. It shall be apparent to one skilled in the art, however, that the invention may be practised without some of these details. Some of the details may not be described at length so as not to obscure the present invention.

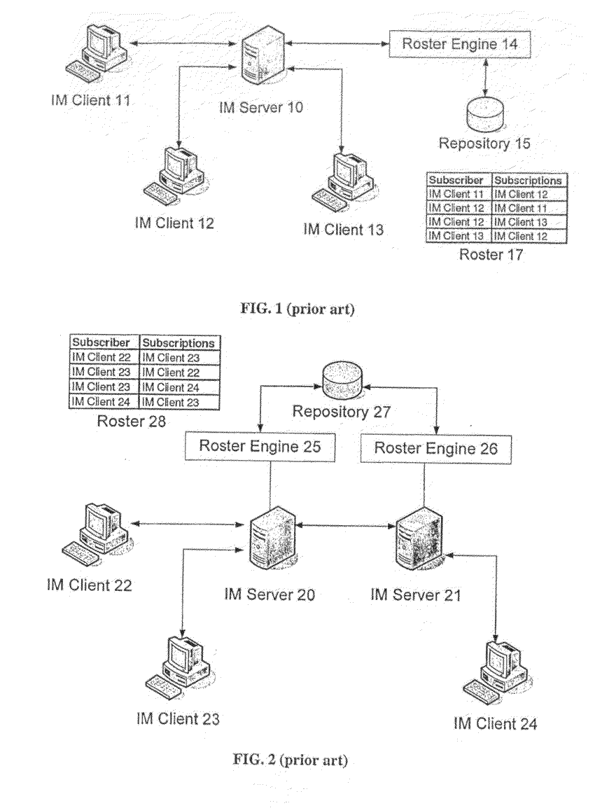

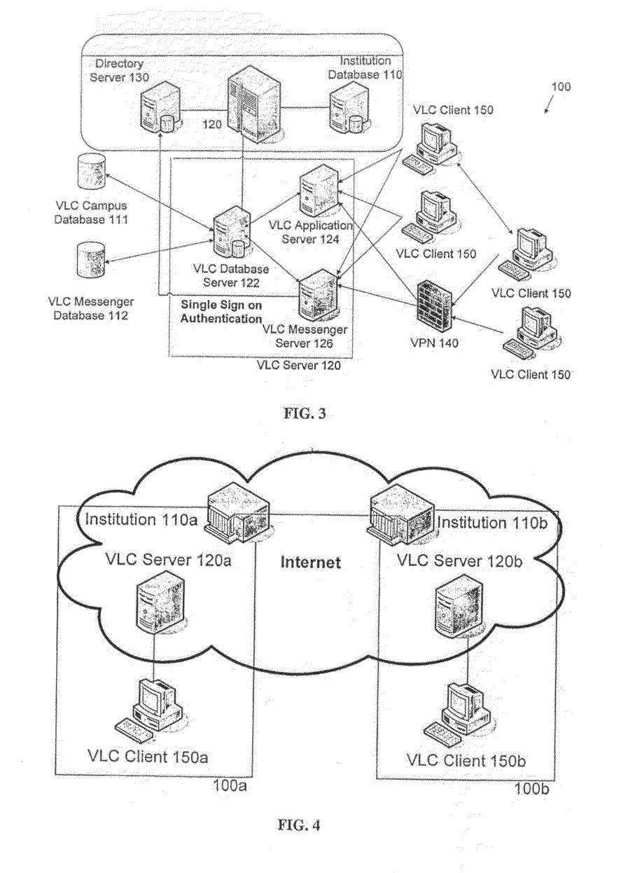

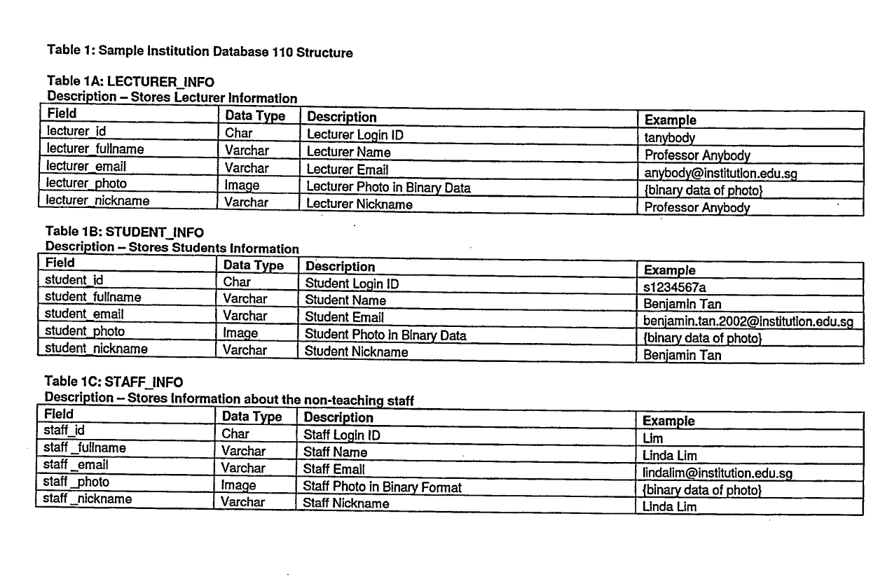

FIG. 3 shows an overall architecture of a campus-wide Instant Messenger (IM) architecture 100 according to an embodiment of the present invention. The IM system 100 serves an entire institution and a Virtual Learning Community (VLC) therein. Referring to FIG. 3, the IM system 100 includes an Institution Database 110, a VLC Server 120 and a Directory Server 130. The VLC Server 120 is connected to both the Institution Database 110 and the Directory Server 130. The VLC Server 120 serves 3 separate logical roles and is shown schematically in FIG. 3 as three separate servers, namely, a VLC Database Server 122, a VLC Application Server 124 and a VLC Messenger Server 126. The VLC Application Server 124 and VLC Messenger Server 126 are separately connected to the VLC Database Server 122. Students, trainees, teaching assistants, lecturers, researchers, administrators, and other staff members of the institution, are identified as VLC Clients 150. All the VLC Clients 150 are connected directly to both the VLC Application Server 124 and the VLC Messaging Server 126. The VLC Messenger Server 126 mimics the task of a prior art IM server 10, 20, 21 as illustrated in FIGS. 1 and 2. The VLC Application Server 124 provides functional extensibility to the VLC Messenger Server 126 though extensible connectors pluggable onto the VLC Messenger Server 126.

In another embodiment of the IM system 100, also shown in FIG. 3, some VLC Clients 150 are each connected to both the VLC Application Server 124 and VLC Messenger Server 126 via an internet connection through a Virtual Private Network (VPN) 140. In this embodiment, the VLC Clients 150 on the internet logs on to the VPN securely before they are connected to both the VLC Application Server 124 and VLC Messenger Server 126.

In an embodiment of the Directory Server 130, the Directory Server 130 is a LDAP (Lightweight Directory Access Protocol) server. In another embodiment, the Directory Server 130 is an Active Directory Server.

In another embodiment of the IM system 100, the VLC Server 120 is a cluster of servers instead of a single server unit. This multi-VLC Servers configuration is provided to support large numbers of VLC Clients 150 in an extensive institution, potentially providing supports to thousands and millions of VLC Clients. In a variation, the VLC Server 120 is a plural clusters of servers.

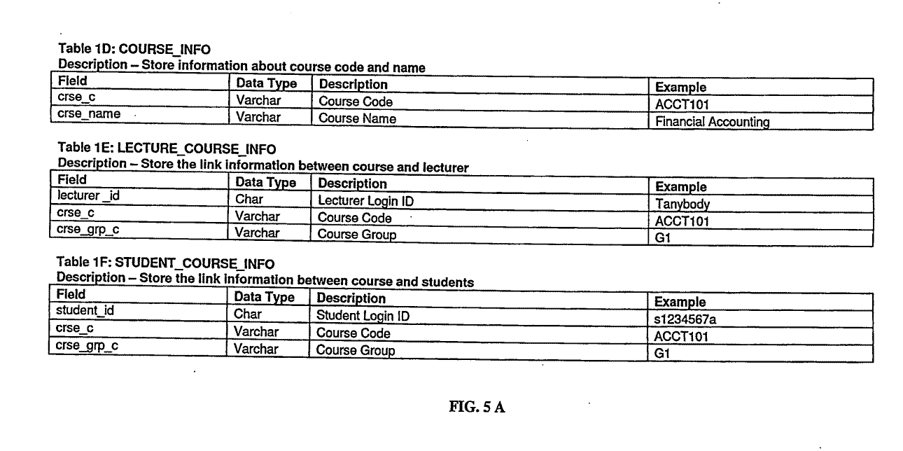

As shown in FIG. 3, the VLC Server 120 is designed to function in both an intranet environment and an internet environment. FIG. 4 shows another embodiment of a virtual learning community comprising of two institutions 110a, 110b, with each institution having its own campus-wide IM system 100a, 100b. As shown in FIG. 4, the two separate IM systems 100a, 100b are connected through the internet. This is different from multi-servers cluster deployments. In this embodiment, each VLC Server 120a, 120b serves a respective institution 110a, 110b. When VLC Clients from one institution wish to communicate with those of another institution, permission is based on a trust relationship which would need to be established between the two institutions. Hence, a VLC Client 150a from an institution can communicate with another VLC Client 150b from another institution via the Internet. This method would also require that the VLC Servers 120a,120b in both institutions can see one another on the Internet and/or VPN. In a variation of the embodiment shown in FIG. 4, the separate institutions 110a, 110b may just be separate campuses of the same institution, for example, when the campuses are geographically separated.

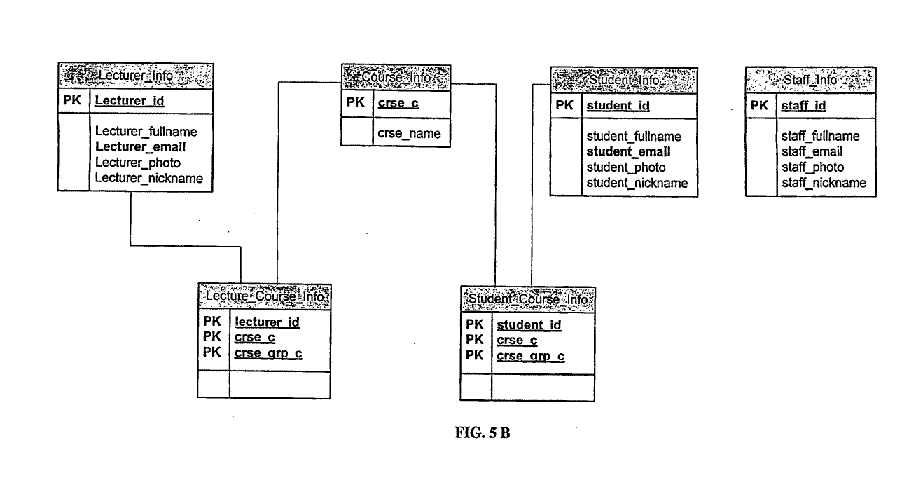

The Institution Database 110 contains personnel records of academic and non-academic staff, details of academic courses/electives, and details of students who have signed up for their respective courses/electives and so on. These details and records vary from institutions to institutions. Tables 1A-1F as shown in FIG. 5A depict parts of typical data structures of the Institution Database 110. FIG. 5B shows a mapping of the data structures shown in FIG. 5A. The VLC Server 120 requires read-only access to the Institution Database 110 and the VLC Server 120 does not modify the data contained in the Institution Database 110.

As shown in FIG. 3, the VLC Server 120 is connected to the Directory Server 130. The Directory Server 130 allows a VLC Client 150 to sign-on to the VLC Server 120 in a single authentication step (known as Single Sign-On) by authenticating users or VLC Clients 150 against data contained in the Institution Database 110. In another embodiment, the Directory Server 130 is an Active Directory Server. In addition or alternatively, the VLC Server 120 allows VLC Clients 150 to sign-on to the VLC Server 120 in a Single Sign-On (SSO) step by using Microsoft Active Directory (MSAD) Services. MSAD allows VLC Clients 150 to log in to the VLC IM system 100 automatically using Microsoft window's login credentials or tokens.

Each VLC Client 150 installs an executable application into one's interface device, such as a computer, a notebook or a tablet with writing and inking capabilities. When installed, these VLC Client applications provide a VLC Client 150 with rich smart-client tools which interact with the VLC Server 120. A VLC Client 150 is then able to connect to the VLC Server 120 without the need to re-compile each application on subsequent log-ins. Details of the VLC Client application tools will be described later.

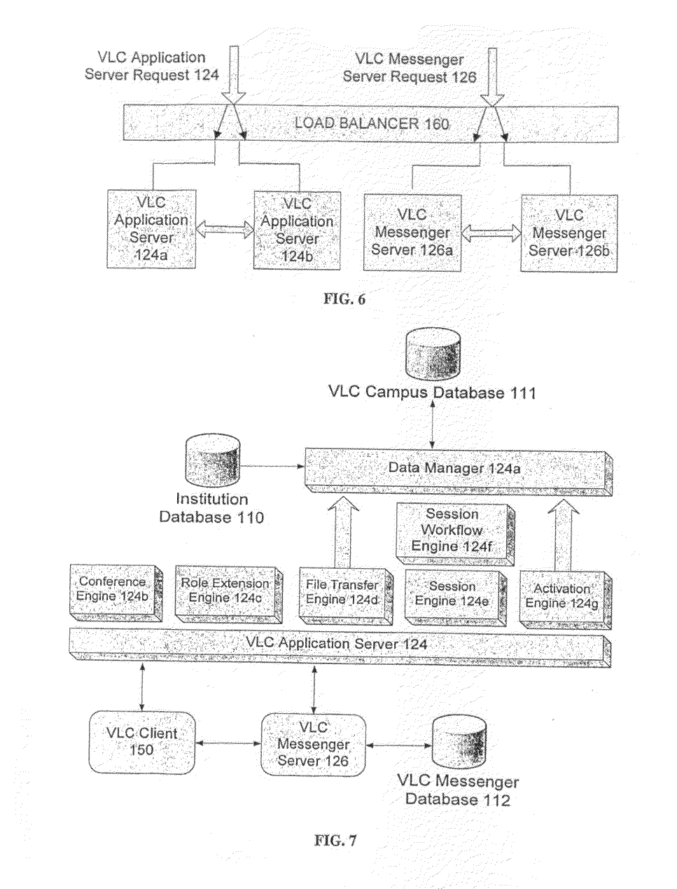

As described earlier, the VLC Server 120 includes 3 logical servers: the VLC Database Server 122, the VLC Application Server 124 and the VLC Messenger Server 126. These logical servers 122, 124, 126 may be physically located in the VLC Server 120, or they may be physically located in separate machines but linked to a common VLC Server 120. In another embodiment of the VLC Server 120, each of the logical server 122, 124, 126 comprises a cluster of machines or a plural clusters of machines. The multi-servers cluster embodiment is provided to support a large number of VLC Clients 150 yet allowing high electronic traffic. In yet another embodiment of the VLC Server 120, a Load Balancer 160 as shown in FIG. 6 is employed to spread the electronic traffic through multiple VLC Application Servers 124a, 124b and VLC Messenger Servers 126a, 126b. The VLC Database Server 122 can be any database server, such as a MySQL, Postgress, Oracle or Microsoft SQL Server. The VLC Database Server 122 is preferably configured to support real-time replication. Real-time replication is useful, for example in the event of a fail-over, that is, when one database server goes down, a backup database server would automatically come online.

The VLC Messenger Server 126 is configured to implement an eXtensible Messaging and Presence Protocol (XMPP), for example, Jabber Software Foundation's protocols RFCs 3920 and 3921. The VLC Messenger Server 126 facilitates the login, presence management and the routing of messages. XMPP allows synchronous and asynchronous communication for Client-to-Client, Client-to-Server and Server-to-Server messaging. In the present IM system 100, some functions of the VLC Messenger Server 126 are extended to the VLC Application Server 124 by the use of pluggable components on the VLC Messenger Server 126. These functional extensions make use of the interfaces provided in the XMPP running on the VLC Messaging Server 126.

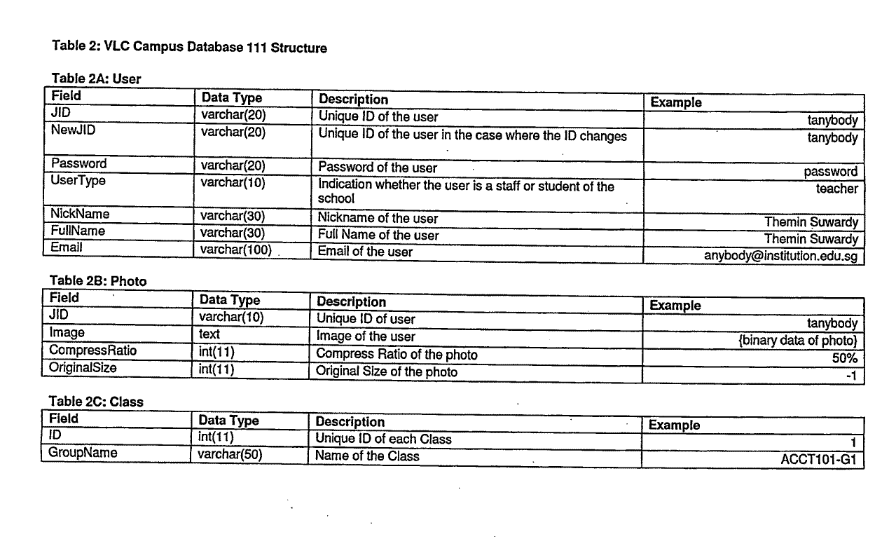

The VLC Application Server 124 hosts a set of engines to provide functional extensibility to the VLC Messenger Server 126. These VLC Application Server 124 engines, as depicted in FIG. 7, are: a Data Manager 124a, a Conference engine 124b, a Role Extension engine 124c, a File Transfer engine 124d, a Session engine 124e, a Session Workflow engine 124f and an Activation engine 124g.

The Data Manager 124a manages the importing and updating of lecturers, students, staff and course information. The Conference engine 124b allows group-based collaborations and interactions through the use of virtual “meeting rooms”. The Role Extension engine 124c allows institutions and corporations to define role-based user information. The File Transfer engine 124d allows both offline and online file transfers. The Session engine 124e assists lecturers or TAs in keeping virtual classroom sessions records, students' attendance, class participation and other data records on persistent storage in a VLC Campus Database 111. The Activation engine 124g activates and manages all VLC Clients accounts. In addition, the Activation engine 124g populates the IM system contact lists. The Session Workflow engine 124f performs routing of classroom session data from one VLC Client 150 to another.

There are three different sets of databases that the VLC IM system 100 architecture in FIG. 3 depends on, namely, the Institution Database 110, the VLC Campus Database 111 and a VLC Messenger Database 112. As shown in FIG. 3, both the VLC Campus Database 111 and VLC Messenger Database 112 are connected to the VLC Database Server 122.

As described earlier, the Institution Database 110 stores data pertaining to lecturers (as shown in Table 1A), students (as shown in Table 1B), staff (as shown in Table 1C) and courses (as shown in Table 1D) within the institution. The Institution Database 110 also stores information pertaining to lecturers in relation to their courses (as shown in Table 1E), and students in relation to their courses (as shown in Table 1F). The data in the Institution Database 110 provide the IM system 100 with a structure to build the VLC Campus Database 111.

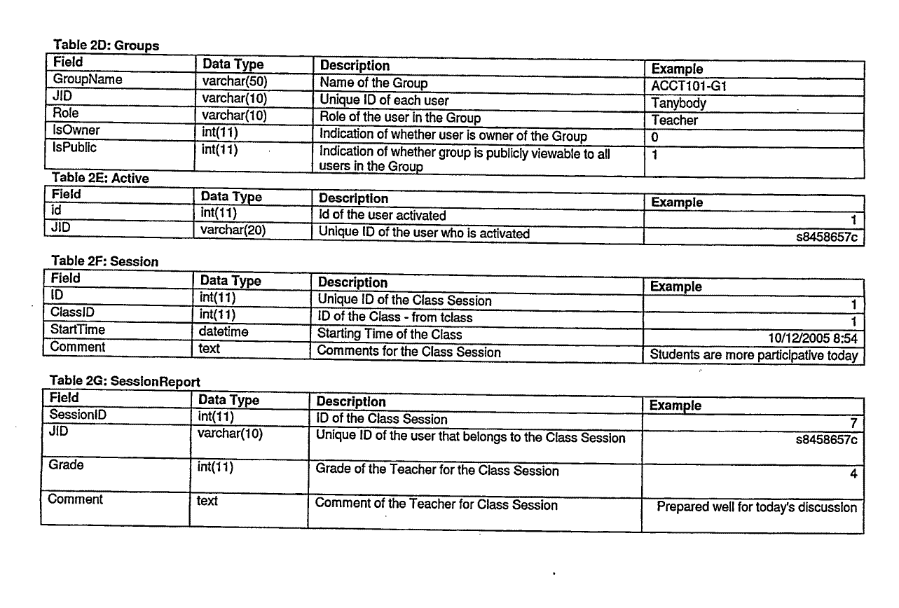

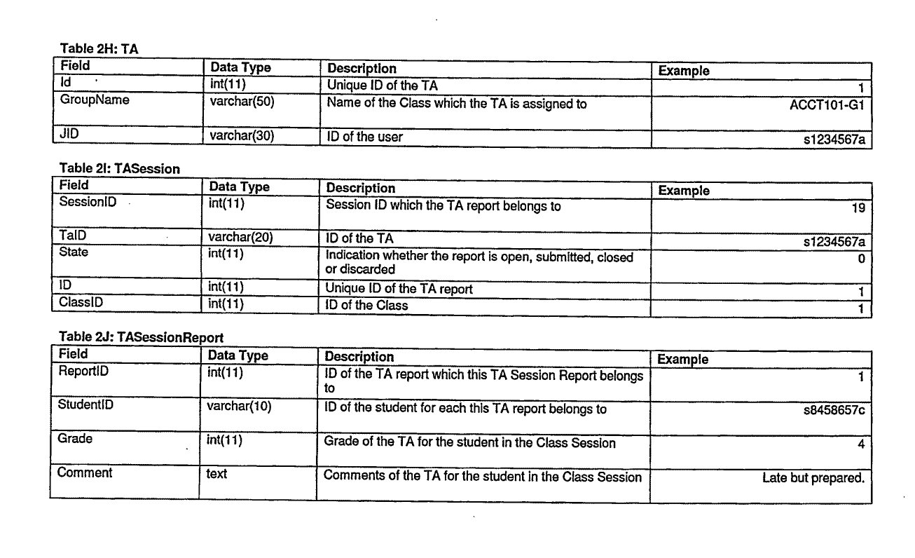

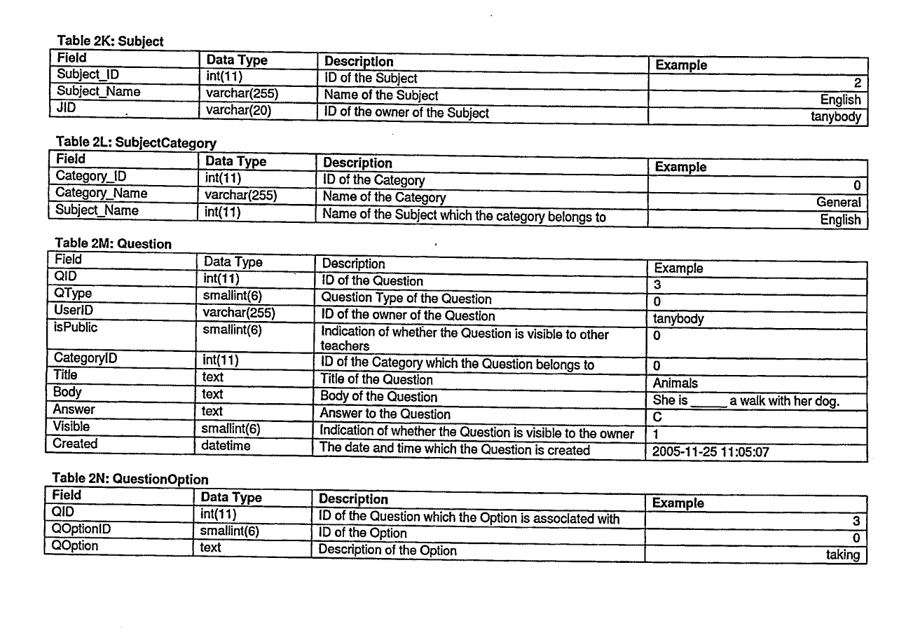

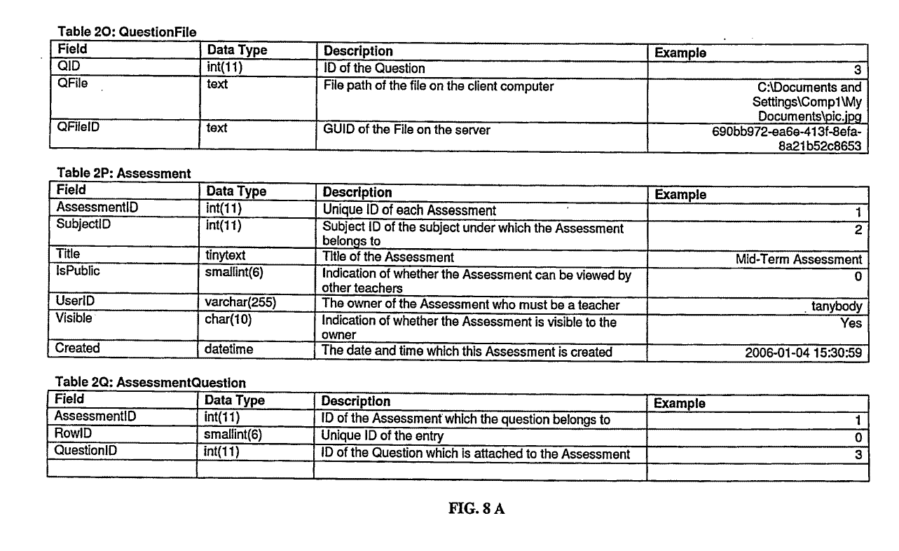

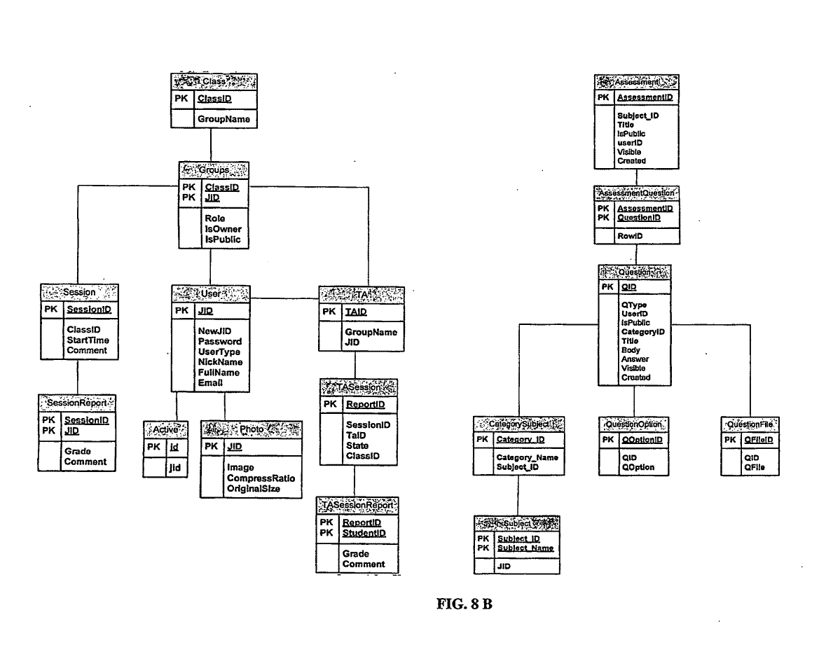

The VLC Campus Database 111 not only includes a replica of the Institution Database 110 data but also stores details about class sessions, student progress, questions and assessments. Tables 2A-2Q in FIG. 8A show part of the entries in the VLC Campus Database 111. Lecturers (Table 1A), Students (Table 1B) and Staff (Table 1C) information are aggregated and stored in a User table (as shown in Table 2A) with their respective role information. If IM Client user images are available, they are added to a Photo table (as shown in Table 2B). Course information (from Table 1D) are populated in a Class table (as shown in Table 2C). The grouping of Lectures and Students to their respective classes (from Table 1E and 1F respectively) are captured and aggregated in a Groups table (as shown in Table 2D). Tables 2A-2D form the core data structure that contains the replication of information from the Institution Database 110. A helper or Active table (as shown in Table 2E) helps the Data Manager 124a updates data from the Institution Database 110 to the VLC Campus and Messenger Databases 111, 112. This updating of lecturers, students, staff and course information to the VLC Campus and Messenger Databases 111, 112 keeps data in the databases current.

When a lecturer starts a class, a class session is created by the Session engine 124e. Lecturers are then able to assess students and track their participation, and record comments on each student's performance or participation. Information of each class Session is stored in a Session table (as shown in Table 2F) whilst a class session report is stored in a SessionReport table (as shown in Table 2G). A teaching assistant (TA) can be assigned to a class to assist a lecturer keep track of class participation and record comments whilst the lecturer concentrates on teaching. TA generated information is stored in a TA table (as shown in Table 2H). The teaching assistant's class session records and reports are stored respectively in a TASession table (as shown in Table 2I) and a TASessionReport table (as shown in Table 2J). The VLC Campus Database 111 also stores questions and assessments information to allow lecturers to quiz students. The questions are stored in a Question table (as shown in Table 2K) and assessments data are stored in an Assessment table (as shown in Table 2L). An assessment can be seen as a number of questions. To allow the easy management of these questions, questions are classified by their subjects (as shown in Table 2M) and categories (as shown in Table 2N). Each question in Table 2K can have a number of options. These question options data are stored in a Table 2O; such question options may include a type of question, for example, a Multiple Choice Question, an Open-Ended Question, and so on. In one embodiment, the question data in Table 2K are stored using the Hyper Text Markup Language (HTML). When creating questions, the present invention allows one to attach supporting file or files to each question as shown by the data in Table 2P. In addition, an assessment (as shown in Table 2L) can be created with links to a number of questions by storing data in a AssessmentQuestion table (as shown in Table 2Q). FIG. 8B shows a mapping of the data structures in Tables 2A-2Q shown in FIG. 8A.

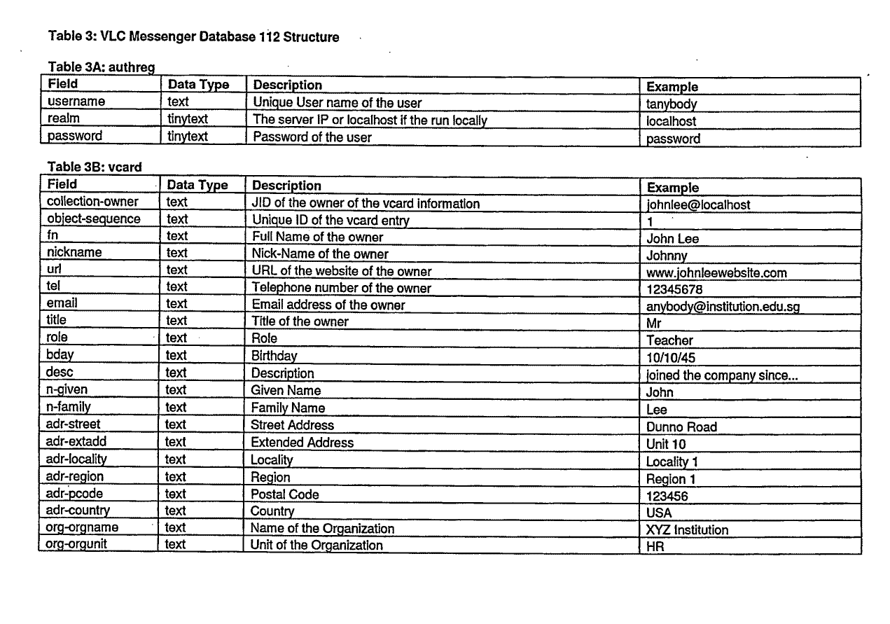

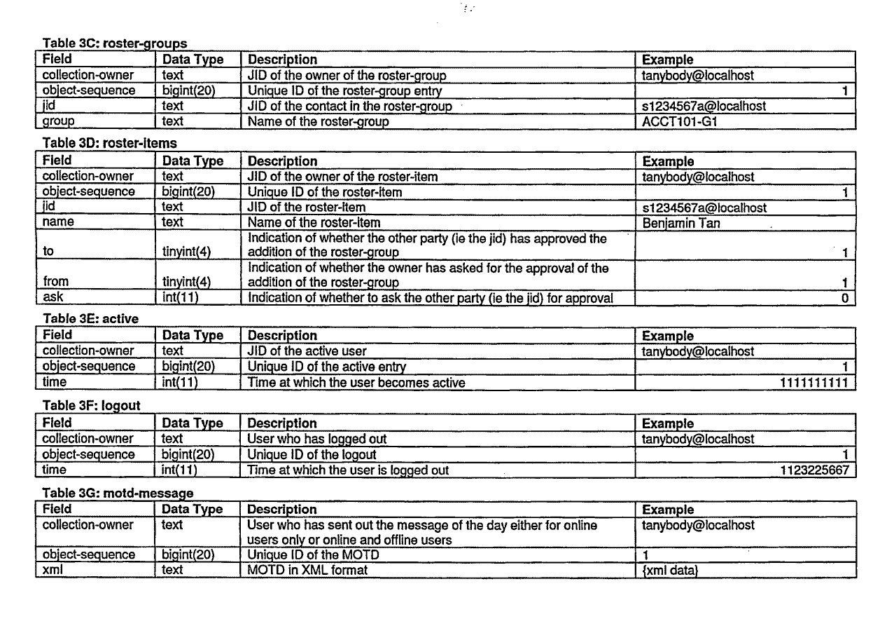

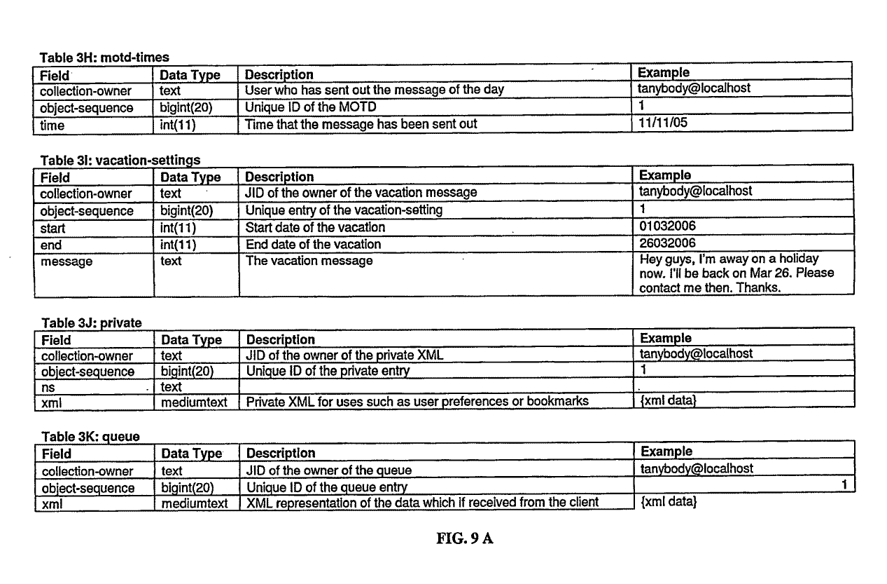

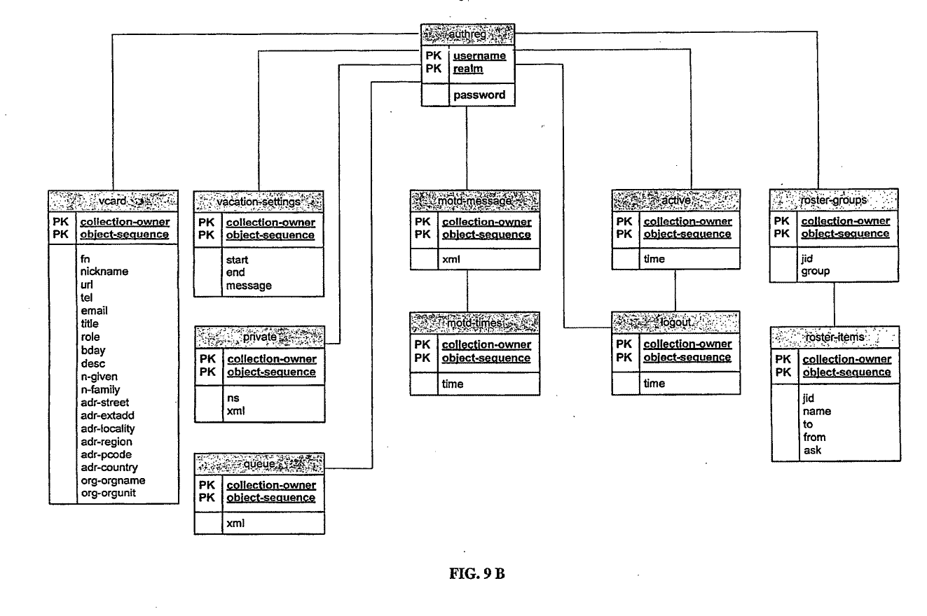

The VLC Messenger Database 112 is used by the VLC Messenger Server 126 for storing information of VLC Clients 150 logging in to the VLC IM system 100. The VLC Client information includes each client's presence information. Parts of the VLC Messenger Database 112 data structures are shown in Tables 3A-3K, which are appended in FIG. 9A. The User data (as shown in Table 2A) are stored in an Authreg table (as shown in Table 3A) and a Vcard table (as shown in Table 3B) after a VLC Client account is activated. As the VLC Clients create their own groups, the Activation engine 124g stores information of these groups in a Roster-groups table (as shown in Table 3C) and links each VLC Client 150 with other users by storing data in a Roster-items (as shown in Table 3D). Once a VLC Client 150 logs in to the VLC IM System 100, the client's contact data is stored in an Active table (as shown in Table 3E) and when the client logs out, the client's contact data are logged in a Logout table (as shown in Table 3F). In addition, System administrators can set messages that will be displayed on certain times and days to all VLC Clients who login during that period. Details of such pre-set messages are stored in a Motd-message table (as shown in Table 3G) and a Motd-times (as shown in Table 3H). The VLC Messenger Database 112 structure also allows VLC Clients to set vacation messages in a Vacation-settings table (as shown in Table 31). Data in the vacation-settings table allow a VLC Client user to query information about another user's availability. In addition, each VLC client user is provided data space to store private availability data (as shown in Table 3J). The private availability data are used to inform a VLC Client user contacting another user who is offline. The private availability data in Table 3J also allow users to send off-line messages and requests to users who are off-line and yet allow the off-line users to receive messages/requests when they next log-in. The VLC Messenger Database 112 also allows the VLC Messenger Server 126 to hold queues of messages for delivery to respective VLC Client users by storing queue information in a Queue table (as shown in Table 3K). Under heavy load, the VLC Messenger Server 126 might not be able to deliver messages as fast as they are received or the VLC Clients 150 might not be receive and process the messages as fast as the VLC Messenger Server 126 delivers. Thus, the VLC Messenger Server 126 stores the messages in the Queue table until the VLC Clients are free to receive them. FIG. 8B shows a mapping of the data structures in Tables 3A-3K shown in FIG. 9A.

The Data Manager 124a is an application that is configured to run at regular predetermined intervals. On a first run after installation of the IM system 100, the Data Manager 124a interacts with the Institution Database 110 and loads all the lecturers, students, staff and course information from Tables 1A-1F into the VLC Campus Database 111. The VLC Campus Database 111 can be seen as a local cache for the Institution Database 110 but differs as follows. The Institution Database 110 is institution-specific and may contain many other data fields which will not be required by the VLC IM system 100. The other difference is that the VLC Campus Database 111 stores additional information on class attendance, student grades and virtual classroom sessions (such as data stored in Tables 2F-2J), questions and assessments (such as data in Tables 2K-2Q). On subsequent runs, the Data Manager 124a heuristically tracks changes in the Institution Database 110 including students and/or lecturers who have joined or left the institution, changes in course/elective groupings as VLC Clients 150, for example students, may have signed up or withdrawn from some courses/electives and also courses/electives that may have been re-designed by a VLC Client 150 Administrator. The Data Manager 124a then updates the VLC Campus Database 111 and the VLC Messenger Database 112. Subsequent regular runs of the Data Manager 124a ensures that changes in the Institution Database 110 data are tracked and the corresponding data in the VLC Campus and Messenger Databases 111, 112 are kept updated. Updating of the VLC Campus and Messenger Databases 111, 112 will be described later.

When a VLC Client 150 has successfully logged in to the VLC IM system 100, the VLC Messenger Server 126 returns a contact listing and presence information to the VLC Client 150. However, the prior art XMPP is more concerned with communication and sending presence information that they limit contacts to only one group. In an educational/training environment, the VLC Clients 150 are structured into lecturers, tutors/TAs, students, researchers and administrators, for example, with members of each group being assigned a role. Typically, a lecturer or a tutor/TA may be involved in more than one academic courses/electives; a student may enrol in more than one academic courses/electives in a given semester; and the VLC Client 150 administrators are given authority to create academic groups. In the present invention, the Role Extension engine 124c intercepts the VLC Client 150 contact listing from the VLC Messenger Server 126 and modifies it. The campus-wide VLC IM system 100 thus allows a VLC Client 150, for example, students to sign-up for multiple courses of their choice or lecturers to take charge of multiple courses/electives. The Role Extension engine 124c allows VLC Client 150 to appear in multiple contact listings having different roles in separate groupings which prior art IM systems would not support. With this Role Extension engine 124c, VLC Client 150 students can create their own study or social groups and add their contacts in the relevant groups. This extended VLC Client contact information is then returned to each VLC Clients 150. The process of allowing a VLC Client user to take on different roles in different groups will be described in detail later.

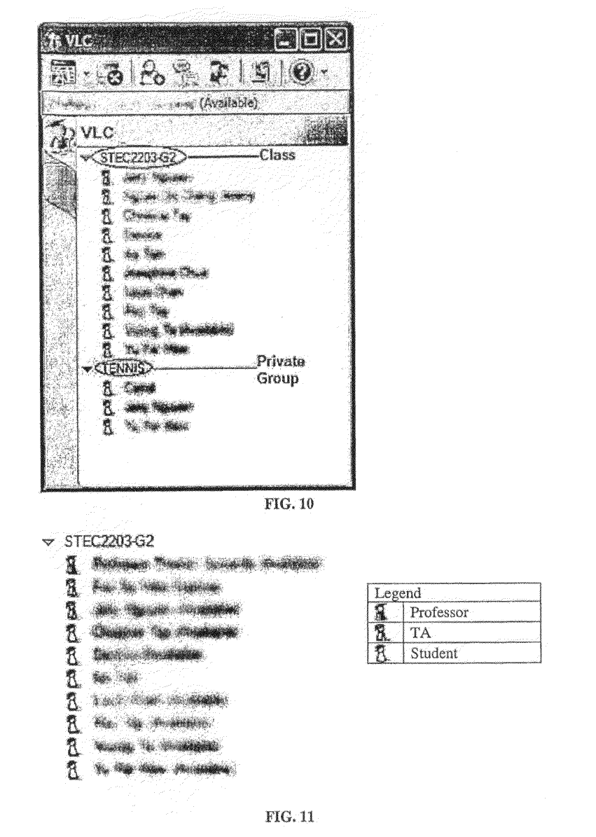

As described, the VLC IM system 100 supports both system-managed groups and user-defined groups. System-managed groups are maintained by the system and cannot be modified or deleted by a VLC Client 150 other than an Administrator. User-defined groups are groups created by a VLC Client 150, for example a student, which the student can manage and populate. For example, FIG. 10 shows two groups, namely, an academic class group STEC2203-G2 and a social/private group TENNIS. STEC2203-G2 is a system-managed group managed by a VLC Client institution administrator whilst TENNIS is a user-defined group managed by a VLC Client, for example a student, in this tennis group.

FIG. 10 also depicts a rendered view of a VLC Client 150's contact list, in this example of a lecturer. As shown in FIG. 10, there are some members appearing in both groups STEC2203-G2 and TENNIS. A prior art IM system would not allow duplication of such a contact listing, less so across groups (see, for example, US patent publication no. US 2005/091250 assigned to Microsoft, relates to merging of duplicate records of a computer-based contact list). As shown in FIG. 11, the roles of members of the class group STEC2203-G2 are differentiated with different icons, that is, to identify a lecturer, a TA or students. With this Role Extension engine 124c, it becomes possible to define a VLC Client 150 with different roles in different groups in a contact list generated with the present IM system 100. For example, a PhD student in a PhD class may be assigned a role as a lecturer in an under-graduate class. Prior art IM systems would not allow duplicate contacts across groups to appear in a contact list and less so to allow any role in a contact list to be changed across groupings.

Like the Role Extension engine 124c, the File Transfer engine 124d is also another extension component of the VLC Messenger Server 126. The File Transfer engine 124d manages both online and offline file transfers among the VLC Clients 150. For example, when a professor delivers lecture notes using the VLC IM system 100, the IM system 100 “pushes” (instead of “pulls”) the file containing the lecture notes out to the professor's VLC Client 150 students who are both online and offline. The File Transfer engine 124d manages file transfers differently from prior art IM systems in that the VLC Clients 150 can pause file transfers and resume them when they next log in. The File Transfer engine 124d thus gives flexibility to the VLC Clients 150 in downloading any files to their learning devices. The other advantage is a throttling of the system bandwidth. By throttling the bandwidth during file transfers, the File Transfer engine 124d helps to reduce choking of the bandwidth of transmissions in the entire campus-wide VLC IM system 100. The other difference from the prior IM system is that when some of the VLC Client 150, for example students, are offline, the File Transfer engine 124d would send each file to each student as each one logs in. File transfer in a prior art IM system is deficient when a recipient client is offline.

The Session engine 124e is a data engine that persistently stores classroom session-based information in the VLC Campus Database 111. The Session engine 124e allows a VLC Client 150, such as a lecturer or TA, to track a class session, student attendance and progress and even interaction responses in a virtual-class.

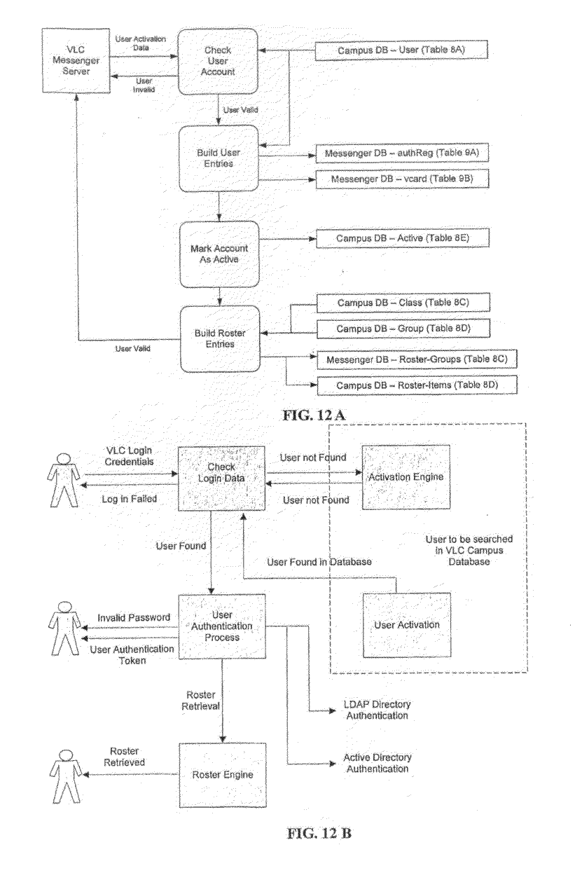

The Activation engine 124g activates and manages all the contact groupings in the entire campus IM system 100. All VLC Clients 150 accounts from the Institution Database 110 are marked as “in-active” upon the first load by the Data Manager 124a. The Activation engine 124g is only invoked when a VLC client user account needs to be activated. When a VLC Client 150 logs in for the first time, the VLC Client 150 issues a sign-in request or data 180 to the VLC Messenger Server 126. The VLC Messenger Server 126 would not locate this client entry in the VLC Messenger Database 112, i.e., fails to recognise the VLC Client 150 in the VLC Messenger Database 112 and issues a failure message 190 to the VLC Client 150. The Activation engine 124g then intercepts this failure message 190 and attempts to discover the VLC Client in the VLC Campus Database 111 (by looking up data in Table 2A in FIG. 8A). If the VLC Client 150 is discovered, the Activation engine 124g duplicates the VLC Client user information from Table 2A to Table 3A and Table 3B and updates the Active VLC Clients data in Table 2E. The Activation engine 124g then proceeds to build up the roster information, as shown in the roster 17, 28 into Tables 3C and 3D. There is a difference between the roster tables in the VLC Campus Database 111 and the VLC Messenger Database 112. The VLC Campus Database 111 only stores the class grouping roster and distinguishes them by the academic classes. The VLC Messenger Database 112 stores both class groupings and personal/private groupings and distinguishes them by the VLC Client user id. This typically means that the VLC Campus Database 111 stores one record of each class-students grouping. The VLC Messenger Database 112 stores the contact information of each student in each class only once; this gives the flexibility of not loading all the VLC Client users' contact information in a class but not yet activated. This activation process is depicted in FIG. 12A.

FIG. 12B illustrates an entire logon process of the present VLC system 100. When a VLC Client 150 logs into the VLC Messenger Server 126 for the first time, the Activation engine 124g activates the VLC Client 150 account following the process shown in FIG. 12A. Upon activation, the process control is then passed back to the VLC Messenger Server 126. On subsequent logins, a VLC Client 150 sign-in data 180 are sent directly to the Directory Server 130 for authentication. Once the sign-in data 180 are authenticated by the Directory Server 130, the sign-in data 180 are then returned a VLC credential/token 181 which gives the VLC Client 150 access to the VLC Application Server 124 and VLC Messenger Server 126 in a successful sign-in. If the sign-in is unsuccessful, access would be denied. Upon a successful sign-in, the VLC Messenger Server 126 returns a roster and presence information 192 to the VLC Client 150. The roster and presence information 192 is intercepted by the Role Extension engine 124c which then returns a structured contact list with role, grouping and presence information 192a to the VLC Client 150. For example, when a VLC Client 150 lecturer has signed in to his course, he is given authority to assign TAs into his course. In addition, VLC Clients 150 students are given liberty to create and rearrange their own private/social groups, such as study or sports groups outside the academic groupings. These private/social groups may involve students from separate courses/electives or campuses linked to the VLC IM system 100.

In the present VLC IM system 100, the VLC Server 120 is different from that of a prior art IM application. In a prior art IM application, a contact list is initially empty. In a corporate IM application, a contact list may include all the employees once, that is, in one group without any role differentiation; the contact list may also include those employees who have not used the IM application. In both prior art IM applications, a contact list builds up as users sign in. However, in the VLC IM system 100 of the present invention, a contact/class list for any given academic course/elective is pre-loaded/populated with the course details from the Institution Database 110. In addition, the contact list is built up gradually as new VLC Clients 150 start using the VLC IM system 100. In another embodiment of the present IM system 100, a contact/class list is partially pre-populating instead of populating the entire class list especially at the beginning of a semester when only a few users would initiate using the IM system 100 or remain in their courses/electives for which they have signed up before a semester begins. When a VLC Client 150, for example a student, signs in successfully, the Activation engine 124g updates the student's contact/class list whilst the Role Extension engine 124c updates the presence information and the VLC Messenger Server 126 indicates that this student is available online. His presence information is then sent to all the members/VLC Clients in his contact/class list to update them that this student is newly available online. Such a change in the status of a contact information in a class list requires multiple activations of information in all the relevant groups already stored in the VLC Messenger Database 112. This is done by running the roster engine 14, 25, 26 in the VLC Messenger Server 126. The roster engine 14, 25, 26 issues a single command and updates the status/presence information of each VLC Client across the relevant groups.

Once a VLC Client 150 is logged in to the VLC IM system 100, a VLC Client 150, whether it is a lecturer, a TA, a student or an administration staff, each is allowed to perform different functionality as defined by a role assigned by the Role Extension engine 124c. Lecturers are given the authority to start classroom sessions, oversee students collaboration sessions and view student's progress tracker reports. The TAs can start class sessions collaboration, a TA Assessment Module, etc. Students typically can start peer collaboration sessions and view their own progress tracker report. Role permission setting is stored in the User data in Table 2A of the VLC Messenger Database 112.

The Session Workflow engine 124f is responsible for routing classroom session data from VLC Client 150 TAs to VLC Client 150 Lecturers. Once the TA has assessed the students for the TA class session, the TA submits the TA SessionReport to a relevant lecturer for review and approval.

The Conference engine 124b allows a VLC Client 150 to efficiently interact with groups of other VLC Clients 150 through the use of virtual “meeting rooms” as compared to a prior art IM system. For example, when a prior art IM client wishes to communicate with 10 other clients, the client would need to send the same information 10 times. With the Conference engine 124b, information is sent to the Conference engine 124b once and the Conference engine 124b manages the task of delivering the information to all the VLC Clients 150 who have joined the “meeting room”.

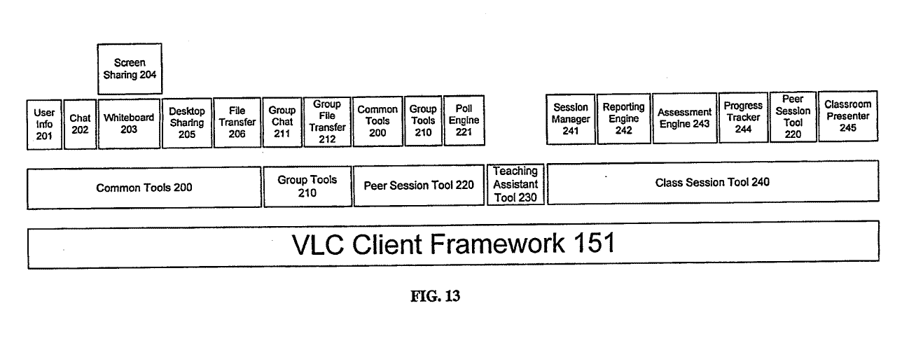

As described earlier, a VLC Client 150 installs an executable application in one's interface device. The VLC Client application is built using a plug-in concept. FIG. 13 depicts a VLC Client application framework 151. As shown in FIG. 13, there are 5 main plug-in tools that are provided for in a VLC Client application framework 151, namely, a Common Tools 200, a Group Tools 210, a Peer Session Tools 220, Teaching Assistant Tools 230 and a Class Session Tools 240.

The Common Tools 200 provide the core or basic tools to facilitate interaction between two VLC Clients 150. As shown in FIG. 13, the Common Tools 200 includes a User Information Tool 201, a Chat Tool 202, a Whiteboard Tool 203, a Screen Sharing Tool 204, a Desktop Sharing Tool 205 and a File Transfer Tool 206.

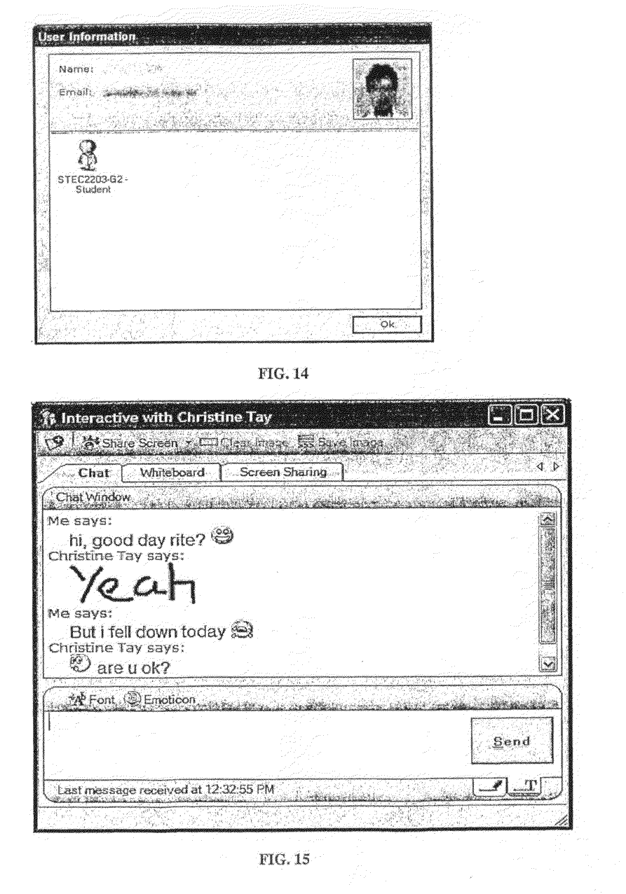

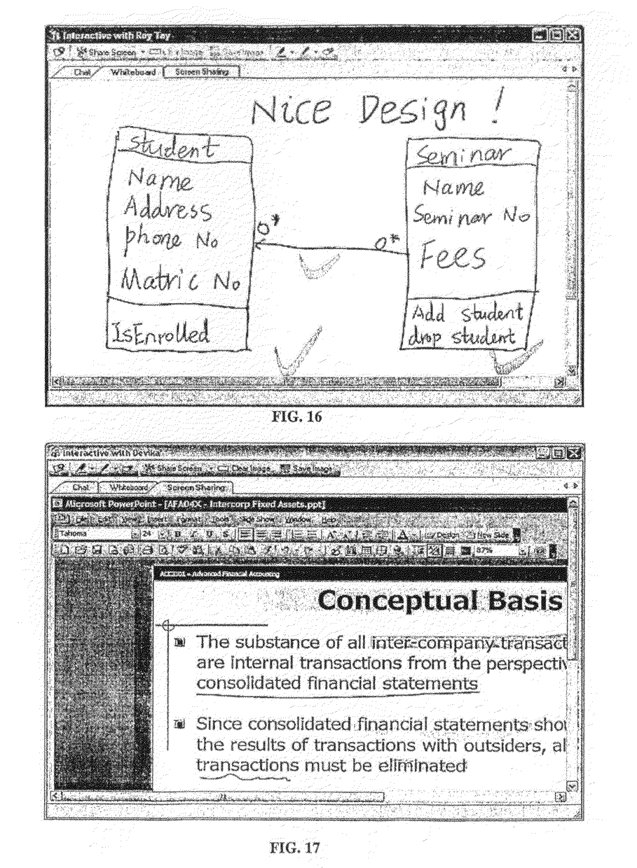

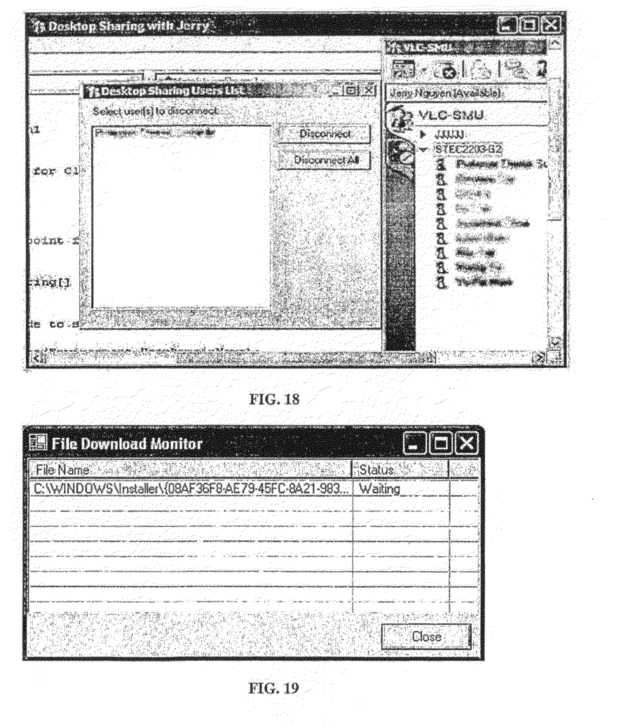

The User Information Tool 201 is used to retrieve information about a VLC Client 150. FIG. 14 shows a user information window that holds the data retrieved from the User Information Tool. This window contains information about a VLC Client student and the courses that the student is enrolled in. The Chat Tool 202 is used to facilitate sending text and inking messages between VLC Clients 150. FIG. 15 shows a chat window which helps facilitate the communication process between two VLC Clients 150. A VLC Client can type and even write/draw on one's input device (such as a Tablet PC) and send it to other VLC Clients 150. The Whiteboard Tool 203 allows VLC Clients 150 to share a common whiteboard and draw questions or answers on them as shown in FIG. 16. The Screen Sharing Tool 204 allows VLC Clients to share or work on screen captures. This can be a capture of a website, a word document or any desktop as shown in FIG. 17. The Desktop Sharing Tool 205 allows a VLC Client 150 to take control and work off another VLC Client's desktop. FIG. 18 shows TA Jerry's desktop sharing with a lecturer. Typically, users collaborate on one desktop. This desktop sharing feature is controlled by a VLC Client owner, who has the ability to terminate the connection with other VLC Clients. In an implementation of the Desktop Sharing Tool 205, the present invention makes use of a RealVNC Server from AT&T Labs (http://www.realvnc.com). The RealVNC Server is modified in the present invention to allow a VLC Client to dynamically startup with a particular random configuration. The File Transfer Tool 206 allows users to send file from one VLC Client 150 to another by interacting with the File Transfer engine 124d. The File Transfer engine 124d sits on the VLC Application Server 124 and connects with the VLC Messenger Server 126. When a single or group file transfer request is received, the File Transfer engine 124d inquires the status of the recipient VLC clients from the VLC Messenger Server 126. If the recipient VLC clients are online, the File Transfer engine 124d initiates a file transfer request. If the recipient VLC client is offline, it requests the VLC Messenger Server 126 to notify the File Transfer engine 124d once the VLC Client comes online. All file transfer requests are channeled to the File Transfer engine 124d, this engine then takes charge of controlling the speeds and data transfers to the recipients. In one embodiment, the File Transfer engine 124d creates a file transfer monitor as shown in FIG. 19. A monitor is created/generated for each file transfer request and the File Transfer engine 124d monitors the amount of data that are currently being transferred and the status (downloading, pause or waiting) of each transfer. If too many file transfers are in progress, the File Transfer engine 124d throttles the bandwidth by controlling the amount of data to be transferred in each file transfer request.

The Group Tool 210 provides the core tools for group interaction. As shown in FIG. 13, the Group Tool 210 includes a Group Chat Tool 211 and a Group File Transfer Tool 212. With the Group Tool 210, VLC Clients can send out messages to groups of VLC Clients using the Group Chat Tool 211 or transfer files to groups using the Group File Transfer Tool 212. The Group Chat Tool 211 interfaces with the Conference engine 124b, whereas the Common Chat Tool 202 facilitates interaction between two individual VLC Clients and does not interface with the Conference engine 124b.

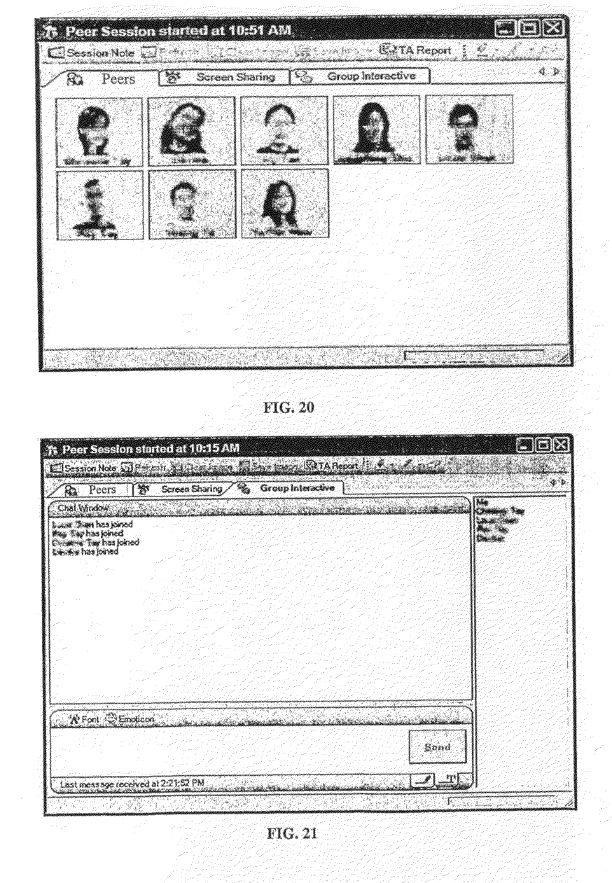

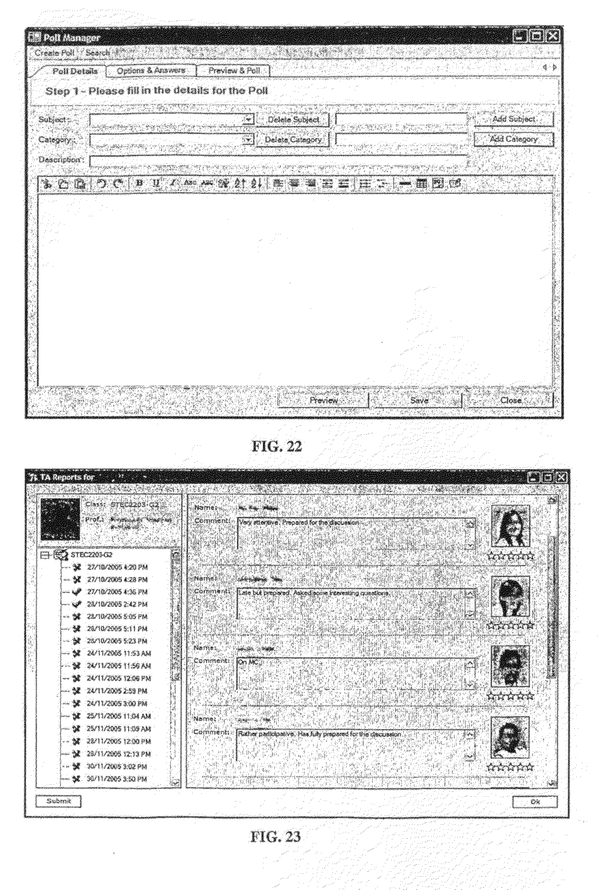

The Peer Session Tool 220 allows VLC student Clients 150 to start a peer session whereby groups of students and/or lecturers can collaborate. A peer session window showing a group of VLC Client students is as shown in FIG. 20. As shown in FIG. 20, the peer session window includes tabs for “Peers”, “Screen Sharing” and “Group Interactive”. VLC Client students, for example, are invited to a peer session via a “join request” and they are added to the “Peers” tab upon joining a peer session. As shown in FIG. 13, the Peer Session Tool 220 comprises components from the Common Tools 200 and Group Tools 210 and a Poll engine 221. VLC Clients 150 can thus activate any of the Common Tools 200 functionalities from the “Peers” tab by right-clicking a mouse key on a student snapshot/image. In addition, the “Group Interactive” tab allows VLC Clients to interact with all the other VLC Clients in the peer session using the Group Chat Tool 211, which interfaces with the Conference engine 124b. FIG. 21 shows a Group Chat Window that differs from the Chat Window in FIG. 15. The Group chat window as shown in FIG. 15 has a list of users that are involved in this chat session. VLC Clients 150 who join a peer session are automatically added to the virtual chat room. VLC Clients 150 can also share Whiteboard and Screens in a peer session. The Poll engine 221 allows VLC Clients 150 to send out short polls or questions to other VLC Clients who have joined a peer session to gather responses in real-time. FIG. 22 shows a screen for allowing VLC Clients 150 to construct their poll questions for sending to users in that peer session. This is useful in conducting short polls to gather responses and feedback on a contentious issue.

A peer session chair 150a is a VLC Client 150 who initiates a Peer Session. In each peer session, each VLC Client 150 can see snapshots of other VLC Clients 150 in a peer session window as shown in FIG. 20. When the Peer Session Tool 220 is started, the peer session chair 150a manually invites other VLC Clients 150 into the peer session. Each member's snapshot is represented by an image of an individual's photograph together with the individual's name near the bottom of the member's photograph. When a member is online, the member's photograph appears in a blue box. When the session chair 150a selects a member, for example for a point of discussions, the box around the member's photograph would turn to green. When a member is off-line, the member would be removed from the peer session window.

The Teaching Assistant Tool 230 is an application tool activated only by a TA. TAs assist lecturers in grading and assessing students. When the Teaching Assistant Tool 230 is activated, the TA is presented with a screen as shown in FIG. 23. With the Teaching Assistant Tool 230, a TA can select a class session and monitor or grades each student's class participation objectively. The TAs' task would relieve a lecturer of the burden of monitoring a virtual class and thus allow a lecturer concentrate on delivering academic lessons. In addition, a TA can record comments on students' participation in each class session whether or not each VLC Client student is active in a group discussion. The Teaching Assistant Tool 230 interfaces with the Session engine 124e, which also manages these student performance records. Once the student performance records of a class session are created by a TA, these performance records are routed to the respective lecturers for review or approval via the Session Workflow engine 124f.

The Class Session Tool 240 is similar in functions to the Peer Session Tool 220 but the Class Session Tool 240 offers a host of additional functionalities to support classroom management. As shown in FIG. 13, the Class Session Tool 240 includes a Session Manager 241, a Reporting engine 242, an Assessment engine 243, a Progress Tracker Tool 244 and a Classroom Presenter 245. In addition, the functions in the Peer Session tool 220, such as the Poll engine 221, are also available in the Class Session tool 240. The other aspect of the Class Session Tool 240 is that it is persistent and all records created with the Class Session Tool 2240 are stored in the VLC Campus Database 111.

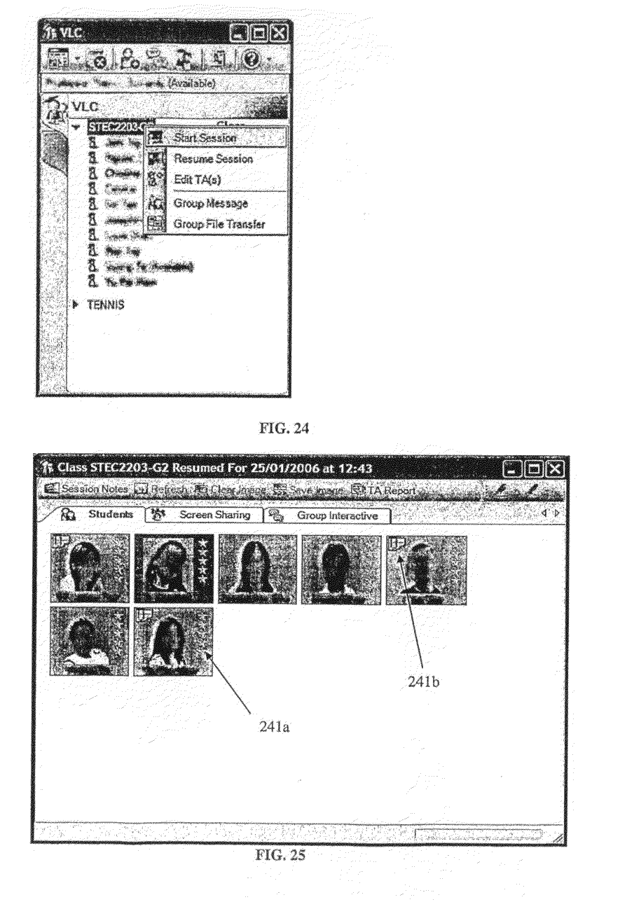

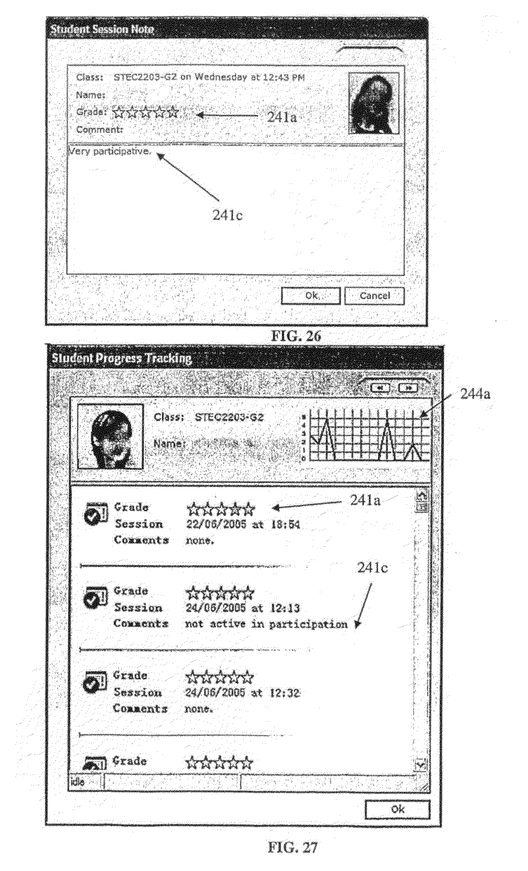

The Session Manager 241 allows VLC Client Lecturers 150 to start class sessions, resume class sessions and edit class sessions as shown in FIG. 24. A typical class session window created by the Class Session Tool 240 is shown in FIG. 25. As in a peer session interface window shown FIG. 20, each VLC Client student 150 in a class session is represented by an individual's photograph with the individual's name near the bottom of each respective photograph. However, in FIG. 25, each individual's photograph has “stars” icon 241a and note tag 241b on the student's snapshot. The class session window thus allows lecturers to grade students immediately by clicking on the “stars” icons 241a. Lecturers or TAs can also right click on the note tags 241b for adding personalized comments about each student's performance as shown in FIG. 26.

The Reporting engine 242 allows lecturers to generate class reports, attendance reports and student progress reports. Class Reports provide an overview of each student's progress report for each and every session in a semester. Attendance reports for each and every session assist lecturers in keeping track of student's attendance. Each Student Progress Report provides an overview report of one student performance across all class sessions. The Reporting engine 242 typically draws its data from the VLC Campus Database 111, for example, from the Session table (as shown in Table 2F) and SessionReport table (as shown in Table 2G). Information about students, lecturers and courses are drawn from the User tables (as shown in Table 2A-2D)

In a conventional classroom, attendance is typically marked manually, together with class participation levels and minutes of classroom discussions, if ever recorded. With the present VLC System 100, attendance is automatically marked as a student signs-in to a class session. In cases where a student is physically in a classroom but does not have access to a learning device, a class initiator (for example, a lecturer or TA/tutor) can still mark the student's attendance manually, for example, by double-clicking on the student's snapshot on the class session window interface as shown in FIG. 25. The VLC IM system 100 allows lecturers to keep track of class participation by clicking on the stars icon 241a. The stars icons 241a and the note tags 241b provide an easy method for lecturers to grade class participation, including taking into account objective comments that have already been recorded of each student's participation.

The student progress tracker 244 allows lecturers to monitor and track a student's classroom participation and performance throughout an entire semester by pulling data stored in the VLC Campus Database 111. The student progress tracker 244 interacts with the Reporting engine 242 and generates a typical student progress tracker report as shown in FIG. 27. As shown in FIG. 27, the progress of a student in each classroom session is graded by a series of stars corresponding to those number of stars in the star icon 241a. The lecturer/TAs' comments on a student's class participation in each session are also reported as contained in the note tags 241b. In addition, the student progress tracker report provides a student progress chart 244a. The student progress chart 244a provides a graphical scale and this allows a lecturer to quickly assess the overall performance of a student. Other enhancement features can also be provided, such as a class average score superimposed on the student progress chart 244a. A lecturer can thus assess his students' performance as classes progress throughout a semester.

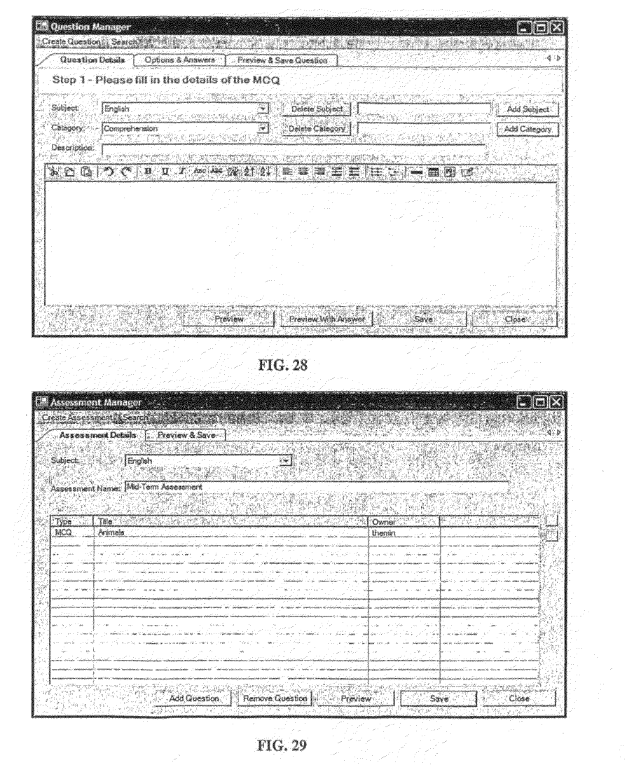

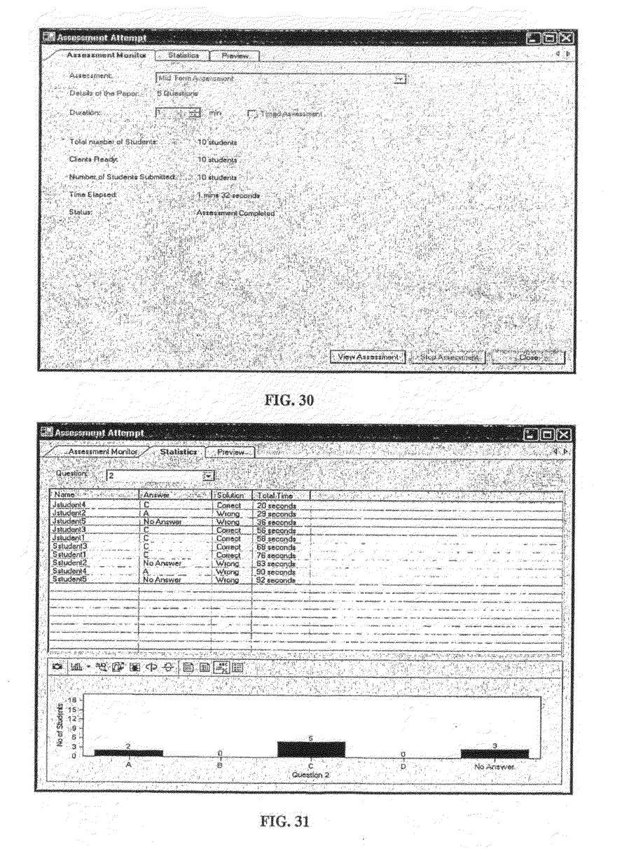

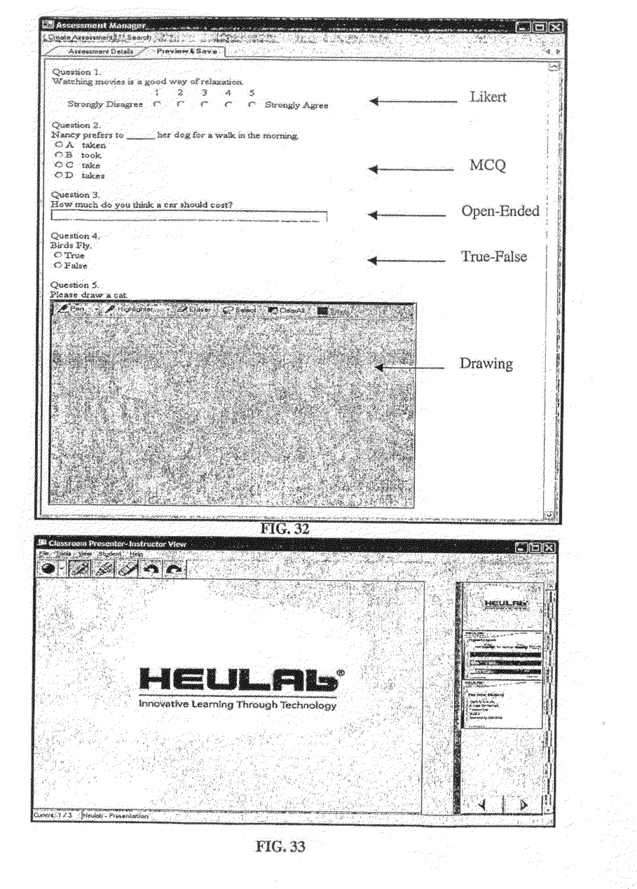

The Assessment engine 243 includes a Question manager 243a and an Assessment manager 243b. The Assessment engine 243 thus allows VLC Clients lecturers or TAs 150 to create questions and build assessments. The Questions manager 243a creates a typical interface window as shown in FIG. 28 whilst a typical Assessment manager 243b interface window is shown in FIG. 29. Once an assessment is built, it is sent out to VLC Client students 150 in a class using an Assessment Monitor interface window as shown in FIG. 30. The Assessment Monitor window as shown in FIG. 31 is generated by the Assessment manager 243b. When the students have completed an assessment, the results are made available through a Statistics interface window as shown in FIG. 31 to the lecturer in real-time. The Statistics window is also generated by the Assessment manager 243b. Each assessment may include questions selected from any combination of the following five types of questions: Multiple Choice (MCQ); Drawing; True/False; Likert Scale; and Open Ended Questions (as shown in FIG. 32).

The Classroom Presenter Tool 245 is provided to allow a VLC Client lecturer 150 to conduct a presentation, for example, using Powerpoint slides, Adobe PDF, and so on. FIG. 33 shows a Classroom Presenter window. As shown in FIG. 33, there is a slide navigator on the right hand side of the presenter window for navigating to other slides of the presentation. In addition, there are some tools, such as, edit, erase, etc near the top, left hand side of the presenter window. For example, the edit tool allows a VLC Client lecturer to compose comments/notes on the presentation material. The Classroom Presenter interacts with the File Transfer engine 124d, File Transfer tool 206 and Group Tools 210. With these tools, the File Transfer engine 124d allow a VLC Client lecturer to simply open the electronic file containing the presentation material and the IM system 100 then sends the file out to all the recipient VLC Clients in a similar manner as the file transfer method described earlier. In addition, each recipient VLC Client has the choice of receiving the presentation file on-line or off-line. When a recipient VLC Client chooses to open the presentation file whilst on-line, the Classroom Presenter Tool 245 allows the recipient client to follow the lecturer as the presentation is conducted. If the recipient client chooses to go off-line, the Classroom Presenter Tool 245 allows the client to go through the presentation at one's own pace.

In most institution's lecturer or TA records are not captured in the Institution Database 110 or are captured later when they are only assigned by the lecturer after a class grouping has been confirmed. In this manner lecturers are able to manage this TA by adding them in real-time to their course listing. Once a TA is added to a class, the Data Manager 124a is transparently invoked to intuitively add the TA to the contact listing of all VLC Client students, TAs and lecturers in the class and make a persistent storage of that information in the VLC Messenger Database 112. Hence, students would see their TAs in their class list once lecturers have assigned the TAs.

In addition or optionally, the lecturers can review the students' inputs and discussions and amend the assessments carried out by the tutors/TAs. These students' assessments would then be made available to the students for their own continuous assessment.

With the Role Extension engine 124c, Session engine 124e and Session Workflow engine 124f, the present IM system 100 allows active interaction between lecturers/TAs and students or among the students themselves. Collaboration tools in a conventional IM are now enhanced. For example, screen capture is now available. With screen capture permitted to use, for example by a lecturer or TA, the lecturer or TA can take control over a student's desktop, mark a point of discussions on the student's desktop and even broadcast the marked desktop to his entire group of students in cyberspace. In this way, an active virtual classroom interaction amongst lecturers and students is provided for in this IM system 100.

While specific embodiments have been described and illustrated, it is understood that many changes, modifications, variations and combinations thereof could be made to the present invention without departing from the scope of the invention.

1. An Instant Messaging system for a Virtual Learning Community (VLC) with VLC Clients (150) including lecturers, teaching assistants, researchers, students and administrators, said system comprising:
a VLC Server (120) comprising at least three logical servers, namely a VLC Database Server (122), a VLC Application Server (124) and a VLC Messenger Server (126), with the VLC Messenger Server (126) running an extensible Messaging and Presence Protocol (XMPP); and
engines (124a-124g) running on the VLC Application Server (124) with pluggable extensions for interfacing with said XMPP, said engines include a Role Extension engine (124c) operable to return a structured contact list (192a) with role, grouping, roster and presence information to each VLC Client (150) so that the VLC Client is allowed to appear in two or more contact groups with different roles.

2. A system according to claim 1, wherein said contact group is a system-managed group, such as an academic group, and/or a user-defined group, such as a social group.

3. A system according to claim 1, wherein one of said VLC Application Server extension engines further comprising: a Data Manager (124a), a Conference engine (124b), a File Transfer engine (114d), a Session engine (124e), a Session Workflow engine (124f) and an Activation engine (124g).

4. A system according to claim 3, wherein the File Transfer engine (124d) allows a VLC Client to pause and resume a file transfer when the VLC Client is online.

5. A system according to claim 3, wherein the File Transfer engine (124d) sends a file to a recipient VLC Client one at a time as each VLC Client logs in to the system.

6. A system according to claim 1, wherein each VLC Client executes an application (151) in one's input device, said application provides a Common Tools tab (200), a Group Tools tab (210) and a Session Tools tab (240).

7. A system according to claim 6, wherein said application provides a VLC Client student with a further Peer Session Tools (220).

8. A system according to claim 6, wherein the application provides a VLC Client lecturer/teaching assistant with a further Teaching Assistant Tools (230).

9. A system according to claim 6, wherein the application provides a VLC Client lecturer/teaching assistant with a further Classroom Presenter Tool (245).

10. A system according to claim 6, wherein the Common Tools tab (200) comprises a User Information tool (201), a Chat tool (202), a Whiteboard tool (203), a Screen Sharing tool (204), a Desktop Sharing tool (205) and a File Transfer tool (206).

11. A system according to claim 10, wherein the Screen Sharing tool (204) allows a VLC Client to share and work on screen captures in cyberspace.

12. A system according to claim 10, wherein the File Transfer tool (206) interacts with the File Transfer engine (124d).

13. A system according to claim 3, wherein the Session engine (124e) and Session Workflow engine (124f) store data presented or generated during classroom activities.

14. A system according to claim 1, further comprising a VLC Campus Database (111) and a VLC Messenger Database (112) connected to the VLC Database Server (122).

15. A system according to claim 1, wherein the VLC comprises a community located in an educational or training institution, where the institutional data on students, staff and courses are stored in an Institution Database (110).

16. A system according to claim 15, wherein the VLC Campus Database (111) stores a replica of the data stored in the Institution Database (110) in addition to data presented or generated during classroom activities.

17. A system according to claim 14, wherein the VLC Messenger Database (112) stores log-in data generated by the Activation engine (124g) and Data Manager (124a).

18. A method for implementing an Instant Messaging in a Virtual Learning Community (VLC) with VLC Clients (150) including lecturers, teaching assistants, researchers, students and administrators, said method comprising the steps of:
linking VLC Clients (150) to a VLC Messenger Server (126;
running an eXtensible Messaging and Presence Protocol (XMPP) on the VLC Messenger Server (126), said XMPP having extensible and pluggable interfaces; and
running functional engines (124a-124g) on a VLC Application Server (124) to cooperate with the XMPP extensible and pluggable interfaces through a VLC Database Server (122), wherein said engines include a Role Extension engine (124c), which is operable to return a structured contact list (192a) with role, grouping, roster and presence information to each VLC Client (150) so that the VLC Client is allowed to appear in two or more contact groups with different roles.

19. A method according to claim 18, wherein said contact group is a system-managed group, such as an academic group, and/or a user-defined group, such as a social group.

20. A method according to claim 18, wherein after a successful sign-in request (180) is authenticated by a Directory Server (130), roster and presence data (192) from the VLC Messenger Server are intercepted by the Role Extension engine (124c), which then returns the structured contact list (192a).

21. A method according to any one of claims 18-20, wherein the VLC Application Server (124) is further configured to run functional extension engines comprising: a Data Manager (124a), a Conference engine (124b), a File Transfer engine (124d), a Session engine (124e), a Session Workflow engine (124f) and an Activation engine (124g).

22. A method according to claim 21, wherein the File Transfer engine (124d) allows a VLC Client to pause and resume a file transfer when the VLC Client is on-line.

23. A method according to claim 21, wherein the File Transfer engine (124d) sends a file to a recipient VLC Client one at a time as each VLC Client logs-in to the system.

24. A method according to any one of claims 18-23, wherein each VLC Client (150) executes an application in one's input device, said application providing a Common Tools tab (200), a Group Tools tab (210) and a Class Session Tools tab (240).

25. A method according to claim 24, wherein said application providing a VLC Client (150) student with a further Peer Session Tools (220).

26. A method according to claim 24, wherein the application providing a VLC Client (150) lecturer/teaching assistant with a further Teaching Assistant Tools (230).

27. A method according to claim 24 or 26, wherein the application provides a VLC Client lecturer/teaching assistant with a further Classroom Presenter Tool (245).

28. A method according to any one of claims 24-27, wherein the Common Tools tab (200) provides a User Information tool (201), a Chat tool (202), a Whiteboard tool (203), a Screen Sharing tool (204), a Desktop Sharing tool (205) and a File Transfer tool (206).

29. A method according to claim 28, wherein the Screen Sharing tool (204) allows a VLC Client to share and work on screen captures.

30. A method according to claim 28 or 29, wherein the File Transfer tool (206) interacts with the File Transfer engine (124d).

31. A method according to claim 21, wherein the Session engine (124e) and Session Workflow engine (124f) store data presented or generated during classroom activities.

32. A method according to any one of claims 18-31, further comprising a VLC Campus Database (111) and a VLC Messenger Database (112) connected to the VLC Database Server (122).

33. A method according to any one of claims 18-32, wherein the VLC comprises a community located in an educational or training institution, where the institutional data on students, staff and courses are stored in an Institution Database (110).

34. A method according to claim 33, wherein the VLC Campus Database (111) stores a replica of the data stored in the Institution Database (110) in addition to data presented or generated during classroom activities.

35. A method according to claim 32, wherein the VLC Messenger Database (112) stores log-in data generated by the Activation engine (124g) and Data Manager (124a).

36. A computer program stored on a computer readable medium for running an Instant Messaging program for a Virtual Learning Community (VLC), the computer program comprising:
an eXtensible Messaging and Presence Protocol (XMPP) having extensible and pluggable interfaces, said XMPP runs on a VLC Messenger Server (126); and
VLC Application engines (124a-124g) cooperating with the extensible and pluggable interfaces of the XMPP, said VLC Application engines run on a VLC Application Server (124) and said VLC Application engines include a Role Extension engine (124c), which is operable to return a structured contact list (192a) with role, grouping, roster and presence information to each VLC Client (150) so that the VLC Client is allowed to appear in two or more contact groups with different roles;
wherein said VLC Messenger Server (126) and VLC Application Server (124) are connected to a VLC Database Server (122).

37. A computer program according to claim 36, wherein said contact group is a system-managed group, such as an academic group, and/or a user-defined group, such as a social group.

38. A computer program according to claim 36 or 37, wherein said VLC Application engines further comprising: a Data Manager (124a), a Conference engine (124b), a File Transfer engine (124d), a Session engine (124e), a Session Workflow engine (124f) and an Activation engine (124g).

39. A computer program according to claim 38, wherein the File Transfer engine (124d) allows a VLC Client to pause and resume a file transfer when the VLC Client is on-line.

40. A computer program according to claim 38, wherein the File Transfer engine (124d) sends a file to a recipient VLC Client one at a time as each VLC Client logs-in to the system.

41. A computer program according to any one of claims 37-40, wherein each VLC Client (150) executes an application (151) in one's input device, said application providing a Common Tools tab (200), a Group Tools tab (210) and a Class Session Tools tab (240).

42. A computer program according to claim 41, wherein the Common Tools tab (200) provides a User Information tool (201), a Chat tool (202), a Whiteboard tool (203), a Screen Sharing tool (204), a Desktop Sharing tool (205) and a File Transfer tool (206).

43. A computer program according to claim 42, wherein the Screen Sharing tool (204) allows a VLC Client (150) to share and work on screen captures in cyberspace.

44. A computer program according to claim 41, wherein the Class Session Tools tab (240) further includes a Classroom Presenter Tool (245).
